(19) United States
(12) Patent Application Publication
(10) Pub. No.: US 2026/0220312 A1
(43) Pub. Date: Jul. 30, 2026

(54) SCALABLE MANAGEMENT OF CRYPTOGRAPHIC INITIALIZATION VECTORS

(71) Applicant: NVIDIA Corporation, Santa Clara, CA (US)

(72) Inventors: Marcin Chrapek, Zurich (CH); Meni Orenbach, Giv'atayim (IL); Ahmad Atamli, Brighton (GB); Oren Duer, Kohav Yair (IL)

(21) Appl. No.: 19/364,929

(22) Filed: Oct. 21, 2025

Related U.S. Application Data
(60) Provisional application No. 63/751,212, filed on Jan. 29, 2025.

(51) Int. Cl. G06F 21/78; G06F 21/57; H04L 9/08; H04L 9/32

(52) U.S. Cl. CPC G06F 21/78; G06F 21/572; G06F 21/575; H04L 9/0819; H04L 9/3236; H04L 9/3247

(57) ABSTRACT

Apparatuses, systems, and methods for scalable multitenant secure storage architecture with cryptographic initialization vector management and disaggregated security processing are disclosed herein. A key management service may allocate non-overlapping initialization vector ranges to storage devices in a data center and transmit the ranges to data processing units. The system may establish a local data processing unit (DPU) as a trusted execution environment for confidentiality and integrity operations and a remote DPU as a trusted execution environment for freshness verification operations, while maintaining a host system in an untrusted state. The system may coordinate between the local and remote DPUs through an untrusted network using attestation protocols, producing verified secure storage operations. The system can maintain device-specific initialization vector range pools, perform infrastructure attestation for device discovery, and implement near zero-overhead read paths with eventual consistency write paths using integrity tree structures stored across disaggregated DPU memory and storage devices.

### RELATED APPLICATIONS

This non-provisional application claims priority to U.S. Provisional Patent Application No. 63/751,212, filed Jan. 29, 2025, entitled “SECURE, SCALABLE, AND EFFICIENT DISAGGREGATED INTEGRITY TREE,” which is incorporated herein by reference in its entirety for all purposes.

### TECHNICAL FIELD

At least one embodiment pertains to data processing systems and techniques for disaggregated storage security using data processing units to provide in-memory verification, batched write processing, and cryptographic coordination for secure storage systems.

### BACKGROUND

Storage systems in data center environments can include verification mechanisms that validate data authenticity and freshness, where maintaining cryptographic tree structures for thousands of concurrent users can present technical challenges regarding performance overhead and scalability. Existing systems may face difficulties with read latency when accessing on-disk cryptographic caches and write contention when multiple threads update tree nodes simultaneously. These limitations can become pronounced in multi-tenant environments, potentially resulting in performance degradation that may affect system throughput and response times for applications.

### BRIEF DESCRIPTION OF DRAWINGS

Various embodiments in accordance with the present disclosure will be described with reference to the drawings, in which:

FIG. 1 is a block diagram of an example system for implementing a disaggregated integrity tree with in-memory verification and batched tree updates, according to at least one or more embodiments;

FIG. 2A illustrates an example organization of an integrity tree structure and storage device, according to at least one or more embodiments;

FIG. 2B illustrates an example organization of a multi-level integrity tree structure with intermediate nodes, according to at least one or more embodiments;

FIG. 3 is a flow diagram of an example read process, according to at least one or more embodiments;

FIGS. 4A and 4B illustrate an example write process, according to at least one or more embodiments;

FIG. 5A is a schematic diagram of an example read process, according to at least one or more embodiments.

FIG. 5B is a schematic diagram of an example write process, according to at least one or more embodiments;

FIG. 6 is a schematic diagram of an example system for implementing a disaggregated architecture for security operations, according to at least one embodiment;

FIG. 7 is a flowchart of an example method of handling read requests, according to at least one embodiment;

FIGS. 8A and 8B are a flowchart of an example method of handling write requests, according to at least one embodiment;

FIGS. 9A-9I are a flowchart of an example method of initialization vector range allocation by a key management service, according to at least one embodiment;

FIG. 10 is a block diagram of an example DPU-based system architecture according to at least one embodiment;

FIG. 11 is a block diagram of an example DPU-based system architecture, according to at least one embodiment;

FIG. 12 is a block diagram of an example DPU-based system architecture, according to at least one embodiment; and

FIG. 13 is a block diagram of an example DPU-based system architecture, according to at least one embodiment.

### DETAILED DESCRIPTION

Data centers face challenges in maintaining data security and performance for cloud storage systems. With thousands of tenants accessing storage resources simultaneously, data centers may use integrity trees to verify that data has not been tampered with (integrity) and that data is the most recent version (freshness). Integrity trees can include a hierarchy of cryptographic values, where each level may combine cryptographic values from the level below using functions like HMAC SHA256, culminating in a root hash that validates the entire dataset.

Some systems store upper tree levels (root and internal nodes) in memory on the main CPU while keeping lower levels (leaf nodes) in on-disk caches. When reading data, systems may verify freshness by comparing the data block's cryptographic value with values stored in the on-disk cache. For write operations, systems may immediately update the entire tree from leaf to root, requiring multiple disk accesses and causing performance bottlenecks. Such systems can encounter various issues, including, for example, read operations suffering from the overhead of accessing slow on-disk storage, and write operations causing significant contention as multiple threads attempt to update shared tree nodes simultaneously.

Aspects of the present disclosure provide systems and techniques that address the above and other performance challenges by using a disaggregated architecture where security operations can be offloaded to specialized Data Processing Units (DPUs) while maintaining data integrity. The integrity tree can be split across different physical locations. Upper levels (root and internal nodes) may reside in memory on a DPU, while lower levels (leaf nodes) may be stored on storage devices.

For read operations, the DPU can reduce the need to access on-disk storage by storing parent cryptographic values directly in each data block's metadata. When a read request arrives, the DPU can retrieve the parent cryptographic value from the block metadata and compare it with the corresponding parent cryptographic value in the in-memory tree. If these values match, the DPU can verify the block's freshness without accessing the on-disk cache. The DPU may periodically update metadata when neighboring blocks are modified to maintain accuracy.

For write operations, the DPU can implement eventual consistency by storing write requests in secure on-chip storage on the DPU. A write request may include the old hash/initialization vector, new hash/initialization vector, storage location, and a validity flag. The actual data may be written to storage immediately, allowing the write operation to complete without waiting for tree updates. The DPU can maintain a counter of pending write requests and may trigger batch updates when this counter exceeds a configurable threshold. During batch processing, multiple write requests may be processed simultaneously, and changes may propagate up the tree from leaf nodes to the root.

In some embodiments, confidentiality and integrity operations may be offloaded to local DPUs while freshness verification may be delegated to remote DPUs that maintain the integrity tree. This separation can allow for specialized processing while maintaining security across untrusted network connections through attestation protocols.

In an example read scenario, a host application can request data block #42. The DPU can receive this request and locate the block on storage. Instead of accessing the on-disk cryptographic value cache, the DPU can read the parent cryptographic value stored in block #42's metadata (e.g., value “a7d9f3e2”). The DPU can then locate the same parent hash in its in-memory integrity tree and find “a7d9f3e2”. Since these values match, the DPU may confirm the block is fresh and return the data to the client. The read can complete without any disk access for verification.

For a write example, a host application can update block #42 with new data. The DPU can receive this write request and may (i) store the request in secure on-chip storage with format [old_hash: “a7d9f3e2”, new_hash: “f8e4d7b9”, location: “block_42”, valid: true], (ii) write the actual data to block #42 on storage, and (iii) return success to the client. The write may complete in milliseconds. Later, when a hundred or more write requests accumulate, the DPU may process them in a batch. The batch processing can include, for example, updating affected leaf nodes, propagating changes upward through the tree, and marking the requests as completed. This batch processing can reduce contention and improve overall system performance.

Advantages of the disclosed techniques include, but not limited to, enhanced read performance by eliminating on-disk cache access, improved write throughput through eventual consistency and batch processing, reduced contention on shared tree nodes, better resource utilization by separating compute-intensive operations onto specialized hardware, improved scalability for multi-tenant environments with concurrent users, and maintained security guarantees through isolation of cryptographic operations on trusted DPUs while allowing untrusted host systems to focus on application workloads.

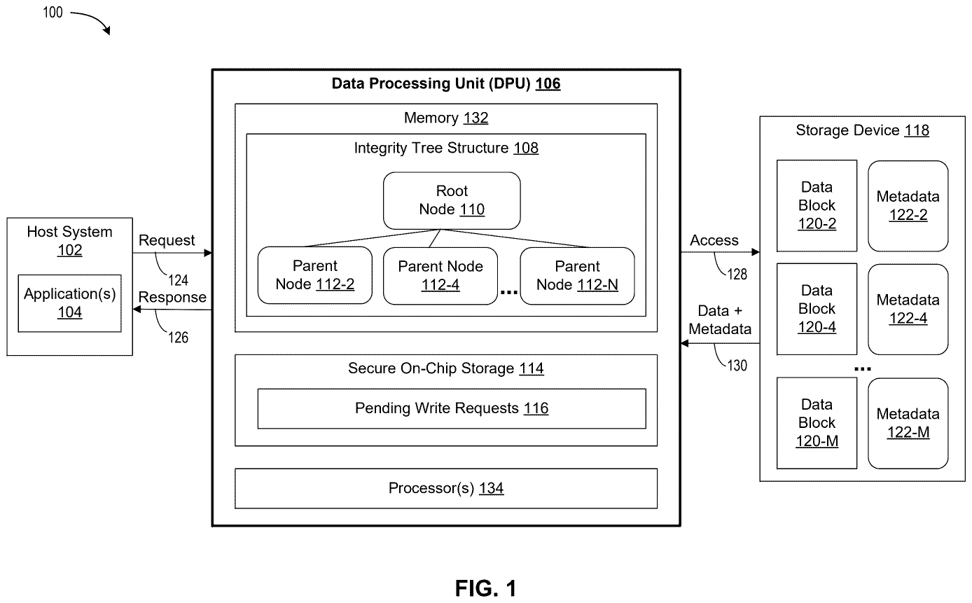

FIG. 1 is a block diagram of an example system 100 for implementing a disaggregated integrity tree with in-memory verification and batched tree updates, according to at least one or more embodiments. The system 100 includes a host system 102 that can contain one or more applications 104. The host system 102 can communicate with a data processing unit (DPU) 106 through requests 124, which may include storage operations, such as read (block address) and write (block address, data). The host system 102 can receive responses 126 back from the DPU 106. The responses may include the requested data for read operations and acknowledgements for write operations. The host system 102 may operate in an untrusted state relative to the DPU 106, enabling the disaggregated security architecture where cryptographic operations are offloaded to the trusted DPU 106 while the host system 102 focuses on application workloads.

The DPU 106 can include one or more processors 134 that can execute instructions for managing integrity tree operations, processing read and write requests, and coordinating with a key management service. The processors 134 may include ARM-based cores, x86 cores, or specialized network processing units (NPUs) optimized for high-throughput data plane operations and cryptographic computations. The DPU 106 can further include memory 132 for storing data structures and caching frequently accessed information. The memory 132 may include at least one of dynamic random access memory (DRAM) for main system memory, static random access memory (SRAM) for high-speed caching operations, and specialized memory, such as ternary content-addressable memory (TCAM), for fast lookup operations. The memory 132 can contain an integrity tree structure 108 that may include a root node 110 and parent nodes (e.g., parent node 112-2, parent node 112-4, . . . , parent node 112-N). The parent nodes can contain cryptographic values derived using hash functions such as HMAC SHA256. The integrity tree structure 108 can allow the DPU 106 to perform rapid in-memory verification operations without accessing slower storage devices. The DPU 106 can also include a secure on-chip storage 114 that can maintain pending write requests 116. The secure on-chip storage 114 may include hardware-protected storage that can be isolated from regular memory operations. The secure on-chip storage 114 may also include dedicated cryptographic hardware for generating initialization vectors and managing cryptographic keys.

The DPU 106 can execute software components including an operating system, libraries for packet processing, and protocol stacks for network communication. The software may also include integrity verification algorithms, batch processing logic for tree updates, and communication protocols with remote key management services. The integrity verification algorithms may implement cryptographic hash functions, such as HMAC-SHA256, SHA256, or BLAKE3 for computing parent node values from leaf node hashes. The batch processing logic may implement write coalescing algorithms that may collect multiple pending write operations and process them simultaneously to reduce tree update overhead. The communication protocols may include secure attestation mechanisms, such as those defined in the Device Identifier Composition Engine specification for establishing trust relationships between DPUs and key management services. These software components can use the processors 134 and memory 132 to implement the zero-overhead read operations and batched write processing described herein.

The system 100 can further include a storage device 118 that can store data blocks paired with metadata blocks using non-volatile memory express (NVMe) metadata block functionality. NVMe metadata functionality allows storage devices to associate additional data (metadata) with each logical block address. The metadata may be read atomically with the primary data in a single NVMe command operation. The storage device 118 can include solid-state drives (SSDs) or other non-volatile storage media with controllers capable of atomic operations for reading both data and metadata simultaneously. The storage device 118 can contain multiple data blocks (e.g., data block 120-2, data block 120-4, . . . , data block 120-M). Each data block may store encrypted user data. Each data block can be associated with a corresponding metadata block (e.g., metadata 122-2, 122-4, . . . , 122-M). The metadata block may include a parent hash, block hash, and/or initialization vector (IV). The storage device 118 can support the disaggregated integrity verification system by enabling the DPU 106 to perform authentication operations using the metadata.

The DPU 106 can transmit data access requests 118 to the storage device 118, and receive data and metadata 130 as a response from the storage device 118. The data and metadata 130 may be accessed through atomic non-volatile memory express (NVMe) operations that can read both data and metadata blocks simultaneously. This architecture can enable the DPU 106 to perform zero-overhead read operations by comparing parent hashes stored in the metadata blocks with corresponding parent nodes stored in the memory 108. The architecture can also manage write operations through the secure on-chip storage 114 for eventual batch processing. Further details with regards to the DPU 106 are described below.

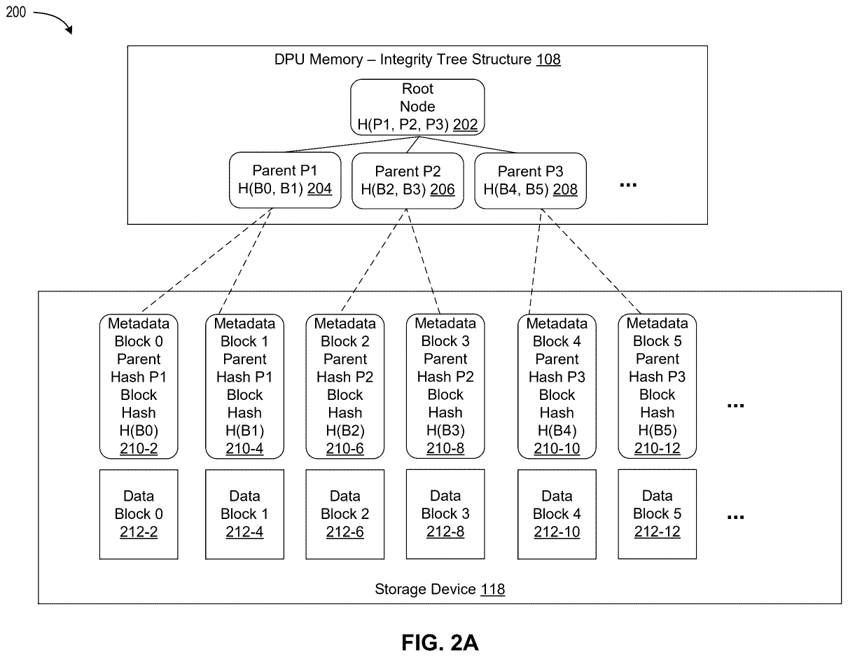

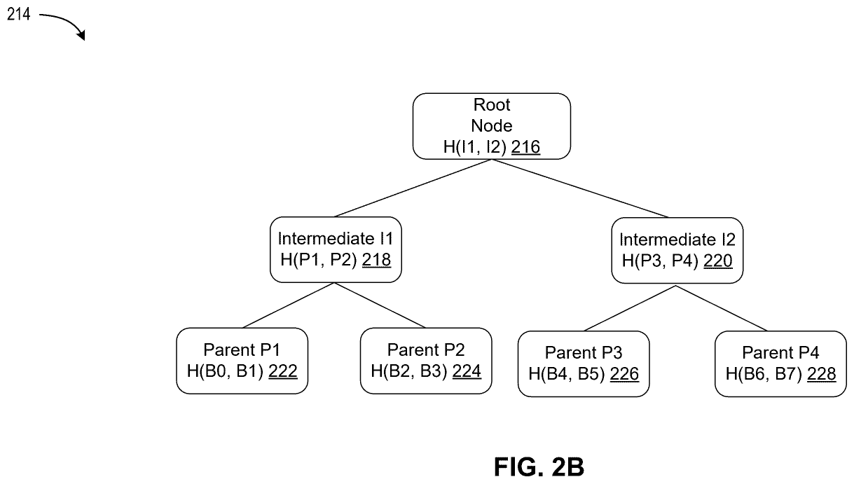

FIG. 2A illustrates an example organization 200 of the integrity tree structure 108 and storage device 118 from FIG. 1, according to at least one or more embodiments. The integrity tree structure 108 may include a root node 202 that can contain H(P1, P2, P3), where H represents a cryptographic hash function, such as HMAC SHA256. Below the root node 202, the tree structure may include parent P1 204 containing H(B0, B1), parent P2 206 containing H(B2, B3), and parent P3 208 containing H(B4, B5). B0, B1, B2, B3, B4, and B5 represent individual data blocks.

The storage device 118 may contain multiple data blocks with their associated metadata blocks. Data block B0 212-2 may be associated with metadata block 0 210-2. Metadata block 0 210-2 may store parent hash P1 and block hash H(B0). Data block B1 212-4 may be associated with metadata block 1 210-4. Metadata block 1 210-4 may store parent hash P1 and block hash H(B1). Data block B2 212-6 may be associated with metadata block 2 210-6, storing parent hash P2 and block hash H(B2). Data block B3 212-8 can pair with metadata block 3 210-8, storing parent hash P2 and block hash H(B3). Data block B4 212-10 can be associated with metadata block 4 210-10, storing parent hash P3 and block hash H(B4). Data block B5 212-12 can be associated with metadata block 5 210-12, storing parent hash P3 and block hash H(B5). A group of data blocks can include the data blocks that share the same parent node in the integrity tree structure. For example, data blocks B0 and B1 can form a group associated with parent P1, while data blocks B2 and B3 can form another group associated with parent P2.

The branching factor N for the integrity tree structure can be 2 as shown in this example. In practice, N may be 100 or more blocks per parent to minimize tree height and memory usage. The dashed lines illustrate how the parent hash values stored in the metadata blocks can correspond to the parent nodes maintained in the DPU memory 108. This organization can enable direct verification without requiring tree traversal or additional disk access. This organization can eliminate the need for on-disk cache access that can cause performance degradation.

FIG. 2B illustrates an example organization 214 of a multi-level integrity tree structure with intermediate nodes, according to at least one or more embodiments. The integrity tree structure may include a root node 216 that can contain H(I1, I2), where H represents a cryptographic hash function, such as HMAC SHA256, and I1 and I2 represent intermediate node values. Below the root node 216, the tree structure may include intermediate node I1 218 containing H(P1, P2) and intermediate node I2 220 containing H(P3, P4). The intermediate nodes 218 and 220 demonstrate a plurality of intermediate nodes, where each intermediate node is connected to at least two other nodes in the tree hierarchy.

Below the intermediate level, the tree structure may include parent P1 222 containing H(B0, B1), parent P2 224 containing H(B2, B3), parent P3 226 containing H(B4, B5), and parent P4 228 containing H(B6, B7). B0 through B7 represent individual data blocks stored on the storage device. This multi-level organization illustrates how intermediate nodes can be positioned between the root node and parent nodes, enabling scalable tree structures.

The tree organization shown in FIG. 2B demonstrates how changes to data blocks propagate upward through multiple levels during batch update operations described in claims 15-19. For example, a modification to data block B0 would require recalculating parent P1 222, then intermediate I1 218, and finally root node 216. The intermediate nodes 218 and 220 may be stored in the DPU memory 108 alongside the parent nodes and root node, enabling the in-memory verification operations while supporting deeper tree hierarchies for large-scale storage systems. The cryptographic values stored in data block metadata correspond to their respective parent nodes, similar to the organization described in FIG. 2A.

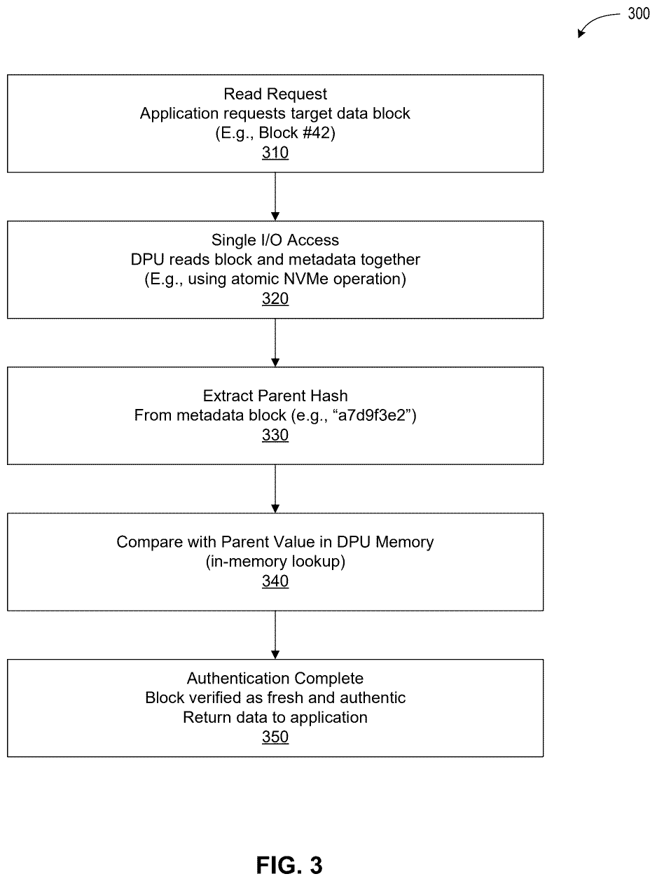

FIG. 3 is a flow diagram of an example read process 300 that can utilize the system components from FIG. 1, according to at least one or more embodiments. At block 310, the application 104 may request to read a target data block, such as Block #42.

At block 320, the DPU 106 may perform a single I/O access operation. The DPU 106 may read both the data block #42 and its metadata block together from the storage device 118 using an atomic non-volatile memory express (NVMe) operation, which may leverage the metadata block feature of NVMe storage devices.

At block 330, the DPU 106 may extract the parent hash from the metadata block. The DPU 106 may obtain a value (e.g., “a7d9f3e2”) that represents the parent cryptographic value.

At block 340, the DPU 106 may compare this extracted parent hash with the corresponding parent value stored in the DPU memory 108. The comparison can occur through an in-memory lookup operation that can access the integrity tree structure without requiring disk access.

At block 350, upon successful comparison where the parent hash from metadata matches the parent node value in memory, the authentication process may complete. The process can verify the block as fresh and authentic. The DPU 106 may return the data to the application 104.

This process can improve read performance by eliminating the need for reading leaf node values from on-disk cache and traversing the integrity tree structure.

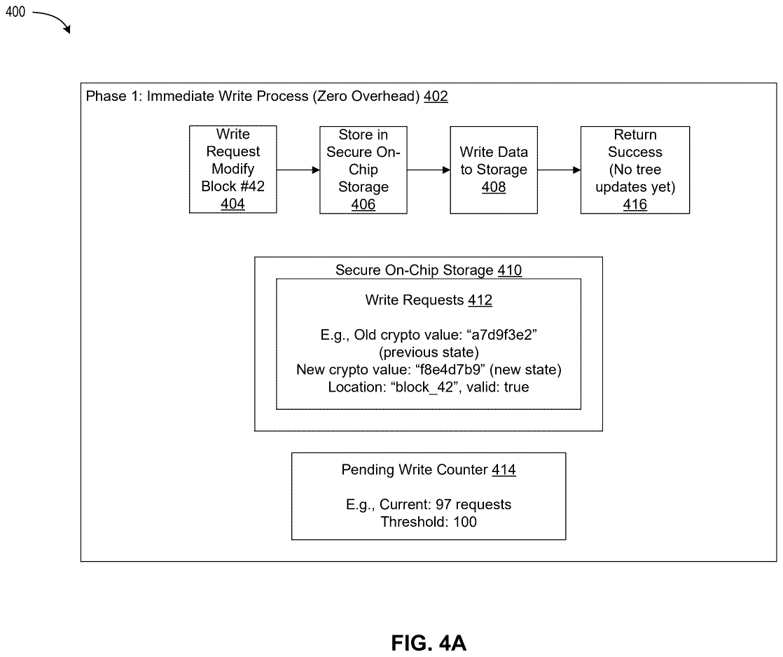

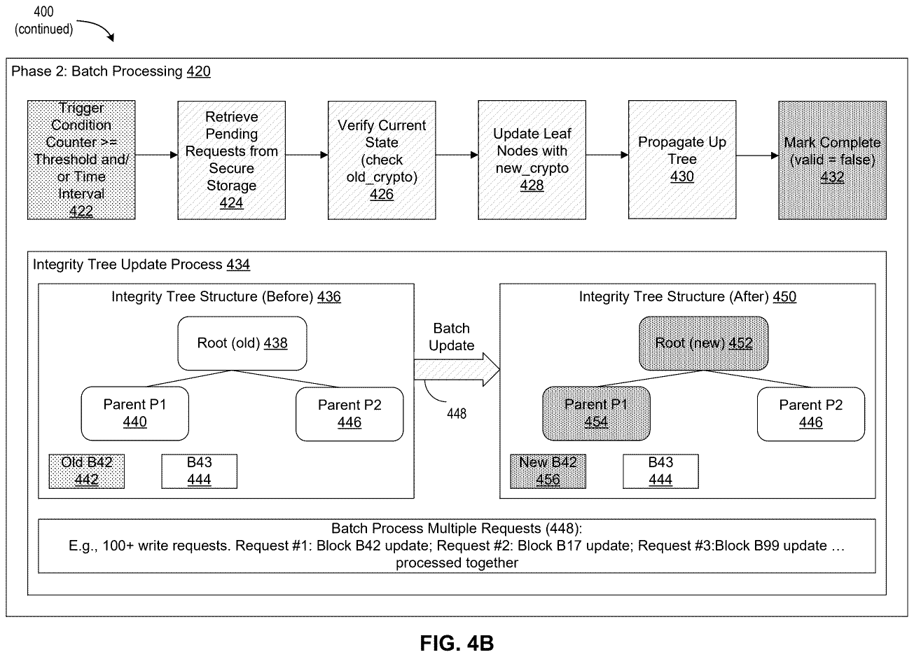

FIGS. 4A and 4B illustrate an example write process, according to at least one or more embodiments. FIG. 4A illustrates a first phase 400 of the zero-overhead write process, showing the immediate write operations that can utilize the secure on-chip storage 114 from FIG. 1, according to at least one or more embodiments. At block 404, the application 104 may generate a write request to modify Block #42.

At block 406, the DPU 106 may store the request in the secure on-chip storage 114 using the write request format 412.

At block 408, the DPU 106 may write the actual data to the storage device 118 immediately.

At block 416, the DPU 106 may return success to the application without performing tree updates. This approach can enable the write operation to complete in milliseconds.

The secure on-chip storage 410 may contain pending write requests 412. Each write request may include an old cryptographic value (e.g., “a7d9f3e2”) representing a previous state of a target data block, a new cryptographic value (e.g., “f8e4d7b9”) representing a new state after modification, a location (e.g., “block_42”) indicating a storage location identifier, and a validity flag (e.g., set to true indicating the pending write operation remains valid).

The secure on-chip storage 410 may also maintain a pending write counter 414. The counter can track the current number of requests (e.g., 97 requests) against a configurable threshold value (e.g., 100). The threshold may be dynamically adjusted based on system performance metrics and memory capacity.

FIG. 4B illustrates a second phase of the zero-overhead write process, which corresponds to batch processing 420 that may occur when the pending write counter 414 from FIG. 4A reaches or exceeds a threshold, according to at least one or more embodiments. At block 422, a trigger condition can be based on the counter reaching the threshold (e.g., 100 requests) or a predetermined time interval.

At block 424, the DPU 106 may retrieve pending requests from the secure storage 410.

At block 426, the DPU 106 may verify the current state by checking the old cryptographic values against current values in the integrity tree structure 108. This verification can detect potential conflicts.

At block 428, the DPU 106 may update leaf nodes with new cryptographic values at positions identified by storage location identifiers.

At block 430, the DPU 106 may propagate changes upward through the tree structure.

At block 432, the DPU 106 may mark processed requests as completed by updating their validity flags to false.

The integrity tree update process 434 shows states before and after a batch update 448 for an example integrity tree structure. The integrity tree structure before tree update 436 shows a root (old) 438, parent P1 440, parent P2 446, old B42 442, and B43 444. After the batch update 448, the integrity tree structure after tree update 450 shows a root (new) 452, parent P1 454 (updated due to change in B42), parent P2 446 (unchanged), new B42 456, and B43 444 (unchanged). The batch update 448 may correspond to the steps 424, 426, 428 and 430, described above. The batch update 448 may handle multiple requests simultaneously. In some instances, the update may handle more than hundred write requests together. The example shows Block B42 update, Block B17 update, and Block B99 update. This approach can reduce contention on shared tree nodes.

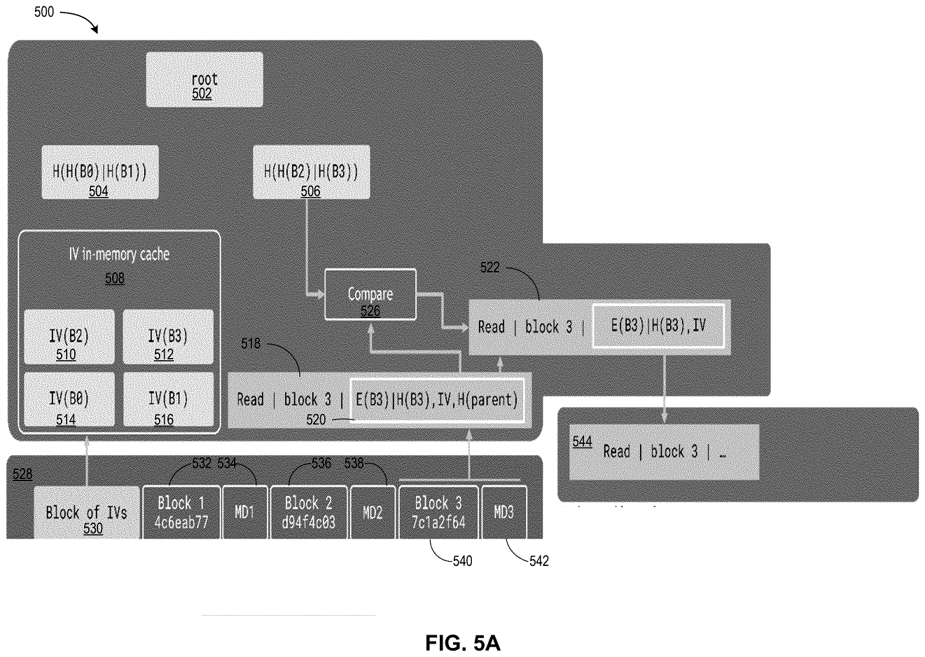

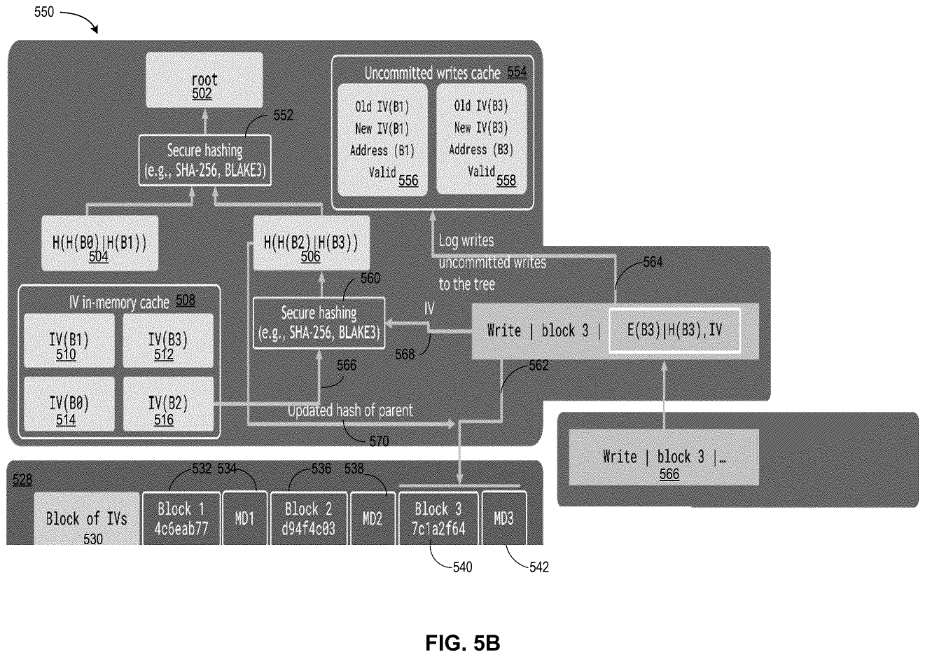

FIG. 5A is a schematic diagram of an example read process 500, according to at least one or more embodiments. B0, B1, B2 and B3 represent data blocks block 0 (not shown), block 1 (532), block 2 (536), block 3 (540) in a storage device 528 (e.g., the storage device 118). The storage device 528 may store the data blocks and their corresponding metadata. In this example, metadata MD1 534, MD2 538, and MD3 542 correspond to data blocks 532, 536, and 540, respectively. A DPU (e.g., the DPU 106) may maintain an integrity tree structure. The example shows a root 502 and parent nodes 504 and 506, which may use cryptographic concatenation operations (indicated by ‘|’). H represents a hashing function. Parent node 504 stores H(H(B0)|H(B1)) and parent node 506 stores H(H(B2)|H(B3)). Cryptographic concatenation operations can combine multiple hash values by placing them adjacent to each other in sequence before applying a hash function. For example, when calculating H(H(B0)|H(B1)), the system may compute individual hash values H(B0) and H(B1), then concatenate these hash strings together (e.g., if H(B0)=“a1b2c3” and H(B1)=“d4e5f6,” the concatenation may produce “a1b2c3d4e5f6”), and apply the hash function H to this concatenated string to produce the parent node value. This concatenation operation can ensure that the parent hash depends on both child values in a specific order, providing cryptographic binding between parent and child nodes in the integrity tree structure.

The example in FIG. 5A shows cryptographic values using initialization vectors (IVs). The storage device 528 may store a block of IVs 530. Initialization vectors are cryptographic parameters used for semantic security. Semantic security requires that an adversary cannot distinguish between encryptions of two different plain texts of the same length. This property can be achieved through the use of unique IVs that ensure identical plaintexts encrypted with the same key produce cryptographically distinct ciphertexts, which can prevent pattern recognition attacks and maintain data confidentiality in multi-tenant environments. Each IV should be unique per encryption operation to prevent vulnerabilities. Reusing an IV with the same encryption key can lead to security vulnerabilities including chosen-plaintext attacks and the ability of attackers to XOR ciphertexts encrypted with reused IVs to recover plaintext information.

An IV in-memory cache 508 in the DPU 106 may include IVs corresponding to data blocks that have been recently accessed. The example shows the cache containing IV(B2) 510, IV(B3) 512, IV(B0) 514, and IV(B1) 516, corresponding to data blocks B2, B3, B0 and B1, respectively. The IV in-memory cache 508 can provide performance optimization by storing initialization vectors for recently accessed data blocks in fast-access memory on the DPU 106.

When performing cryptographic operations, such as encryption, decryption, or hash calculations, the system may need both cryptographic keys and initialization vectors. The IV in-memory cache 508 can guarantee IV uniqueness. Each cached IV represents the specific cryptographic state used during that block's encryption, ensuring that verification operations can confirm both data authenticity and the semantic security properties provided by proper IV management. Rather than recalculating or retrieving IVs from storage for each operation, the cache can maintain frequently used IVs (such as IV(B0) 514, IV(B1) 516, IV(B2) 510, and IV(B3) 512) in the DPU memory. This caching mechanism can reduce computational overhead and storage access latency, particularly during batch processing operations where multiple blocks may require cryptographic processing simultaneously. The IV in-memory cache 508 can guarantee IV uniqueness by ensuring that each cached IV corresponds to its specific encryption operation, maintaining the security properties that prevent pattern recognition across encrypted data blocks. The IV in-memory cache 508 may operate using caching policies, such as least-recently-used (LRU) eviction, to maintain optimal performance while managing memory usage.

In at least one embodiment, the application 104 can request the DPU 106 to read block 3. The DPU 106 may initiate a read operation 518 for the block 3. The operation may fetch the data 540 (the value ‘7c1a2f64’) for block 3 as well as the metadata 542 corresponding to this data block. This data may be encrypted (E represents encryption). The encryption of block 3 used the unique initialization vector IV(B3) to ensure that even if block 3 contained identical plaintext to other blocks, the resulting ciphertext would be cryptographically distinct, preventing pattern analysis attacks across the storage system. An atomic NVMe operation may retrieve multiple components from the storage device 528. This may include the encrypted data E(B3) containing the actual user data, the block hash H(B3) that provides integrity verification for the data itself, the initialization vector IV(B3) that was used during encryption of the block and should be available for decryption while maintaining the semantic security properties established during the original encryption operation, and the parent hash H(parent) that represents the cryptographic value of the parent node governing this block. The encrypted data E(B3) and block hash H(B3) may be stored together as a unit (indicated by E(B3)|H(B3)), while IV(B3) and H(parent) may be stored in the associated metadata block 542. These values may be retrieved simultaneously through a single atomic storage operation, eliminating the need for multiple disk accesses. The DPU 106 may then access the corresponding parent node 506 from its in-memory integrity tree structure 108 and perform a comparison 526 between the parent hash value H(H(B2)|H(B3)) stored in the parent node 506 and the parent hash value H(parent) retrieved from the metadata 542. If the hash values match 522, the DPU 106 may provide 544 the data for block 3 to the application requesting the data.

FIG. 5B is a schematic diagram of an example write process 550, according to at least one or more embodiments. This example assumes the integrity tree structure components (the root 502, and parent nodes 504 and 506), the IV in-memory cache 508, and the state of the storage device 528, described above in reference to FIG. 5A.

In at least one embodiment, the DPU 106 can receive a write request 566 for block 3. The write operation may require a new unique initialization vector to be generated for the updated block 3 to maintain semantic security. Reusing the previous IV would compromise the cryptographic properties that prevent identical plaintexts from producing identical ciphertexts. In response to the write request, the DPU 106 may initiate a write 562 of data corresponding to the write request to the block 3 540 in the storage device 528. The DPU 106 may also log or store 564 a pending write request to an uncommitted writes cache 554 (e.g., the pending write requests 116), which may be used for updating the integrity tree structure (e.g., as part of a batch update). The uncommitted write requests 554 may include write requests for various data blocks. In this example, write request 556 includes old IV, new IV, address and validity for block B1, and write request 558 includes old IV, new IV, address and validity for block B3. The write request 558 is stored as a result of the pending write request 564.

For batch updates, the DPU 106 may calculate a secure hash 560 (e.g., using SHA-256, BLAKE3) based on the IVs (e.g., IV(B3) 512 and IV(B2) 516) in the in-memory cache 508, and the new IV 568 calculated from the write request (stored in the uncommitted write cache 554 (as part of the pending write request 558). The batch update process can maintain IV uniqueness across all affected blocks while preserving the semantic security properties. Each block can retain its unique IV to ensure that the updated integrity tree reflects both data authenticity and the cryptographic distinctiveness required to prevent pattern recognition attacks. The DPU 106 may use the secure hash 560 to update the cryptographic value stored in the parent node 506 (H(H(B2)|H(B3))), which is the parent for blocks B2 and B3. The DPU may also compute a secure hash 552 of the parent nodes 504 and 506, and update the root 502. The updated hash for the parent node 506 may be used to update the hash of parent in the metadata 542 for block 3 in the storage device 528.

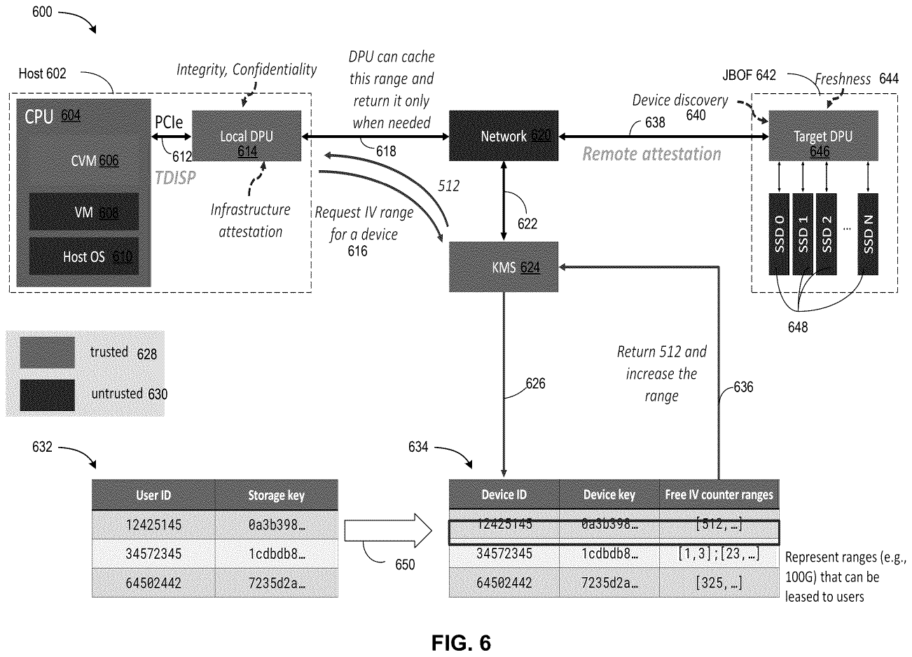

FIG. 6 is a schematic diagram of an example system 600 for implementing a disaggregated architecture for security operations, according to at least one embodiment. The system can include a host 602 with CPU 604, confidential virtual machine (CVM) 606, virtual machine (VM) 608, and host operating system (OS) 610. The CPU 604 may connect via PCIe 612 and Trusted Device Interface Security Protocol (TDISP) to a local DPU 614. The local DPU 614 may handle integrity and confidentiality operations.

The local DPU 614 may also perform infrastructure attestation. Infrastructure attestation can involve the local DPU 614 cryptographically verifying the integrity and authenticity of data center infrastructure components before establishing trust relationships. This process may include validating the hardware and firmware signatures of storage devices (SSD 0, SSD 1, SSD 2, . . . , SSD N 648), verifying the cryptographic credentials of the target DPU 646, and confirming the secure boot status of system components. The infrastructure attestation process can enable device discovery 640 by identifying available storage resources and validating their trustworthiness before allowing data operations. This attestation can provide a foundation of verified infrastructure components that can participate in a zero-trust security architecture.

The host 602 can connect through a network 620 to a Just a Bunch of Flash (JBOF) 642, which may include a target DPU 646 (e.g., the DPU 106) and multiple storage devices (e.g., SSD 0, SSD 1, SSD 2, . . . , SSD N 648). The target DPU 646 may manage freshness operations 644 and device discovery 640. The target DPU 646 can perform remote attestation 638 with the local DPU 614 to establish trusted communication. The CVM 606, the local DPU 614, and the target DPU 646 are components that are trusted 628. The VM 608, the host OS 610, the network 620, and the storage devices 648 are components that are untrusted 630. This disaggregated architecture can implement a zero-trust security framework where no component is inherently trusted, and communications between trusted components may need cryptographic verification and attestation. The zero-trust approach can ensure that if untrusted components are compromised, the integrity of security operations can remain protected through hardware-based isolation and continuous verification protocols. In at least one embodiment, the local DPU 614 and target DPU 646 each may operate as a trusted execution environment that provides hardware-backed isolation for cryptographic operations. A trusted execution environment may include a secure processing area with dedicated memory and cryptographic capabilities that are isolated from untrusted system components. The trusted execution environment can prevent unauthorized access to cryptographic keys, initialization vectors, and integrity tree structures even if the host system or network is compromised.

Key management service (KMS) 624 (which is also a component that is trusted 628) can provide IV range management to ensure unique initialization vectors across the disaggregated storage system. For encrypting data in data blocks, an encryption algorithm may use a key and an initialization vector (IV). The IV should be unique between encryptions for the same key. The block number may not be used as the IV because predictable IVs would compromise the semantic security properties that prevent pattern recognition across encrypted data. This is not an issue for a local drive but generating unique IVs across a data center with thousands of tenants using the same key can be a challenge. Generating random IVs may need thousand petabytes of writes for the lifetime of an SSD. Using a counter may not guarantee exclusive ranges and may need expensive synchronization as the number of tenants increase.

As the data center scales from hundreds to thousands of tenants, counter-based IV generation may face significant challenges. Each tenant may have multiple DPUs and storage devices, and coordinating unique counter ranges across thousands of tenants may require expensive cross-tenant synchronization mechanisms that could become performance bottlenecks. For example, if ten thousand tenants each need to coordinate counter ranges across multiple devices, the synchronization overhead could require millions of coordination messages, creating latency and potential points of failure. The KMS 624 can address this scalability problem by pre-allocating non-overlapping IV ranges to each device, eliminating the need for real-time coordination between tenants while ensuring IV uniqueness across the data center.

The KMS 624 may implement IV leases for unique IVs. The KMS 624 may extend a typical key management table 632 storing user identifiers and storage keys to additionally store (650) a table 634 including device identifier, device key and corresponding free IV counter ranges. The IV range allocation can address the birthday paradox problem in distributed systems where random IV generation across thousands of devices could lead to collisions. The IV range allocation can also solve the coordination overhead problem where counter-based approaches would require expensive synchronization protocols across multiple data centers.

The key management table 632 may store user-level cryptographic information, where user identifiers represent unique tenant/customer IDs (such as “12425145”) that identify each organization or customer using the storage system, and storage keys represent the master encryption keys (such as “0a3b398 . . . ”) used to encrypt and decrypt that specific tenant's data blocks. The extended table 634 may store device-level cryptographic information, where device identifiers represent unique hardware identifiers for individual physical storage devices (such as SSD 0, SSD 1, SSD 2), and device keys represent cryptographic keys specific to each storage device used for device authentication, secure communication, and device-level operations. This two-tier approach can separate tenant-level data encryption (using storage keys) from device-level infrastructure security (using device keys), enabling secure multi-tenant operations across shared physical hardware. The free IV counter ranges represent ranges that can be leased to users. The local DPU 614 can request (via the network 620) the KMS 624 for an IV range 616 for a storage device (e.g., SSD 2). The KMS 626 may access the table 634 to identify the free IV counter range for the device identifier for the device key, and return (636) a free IV in the range (e.g., 512) and update the range (e.g., increase the range).

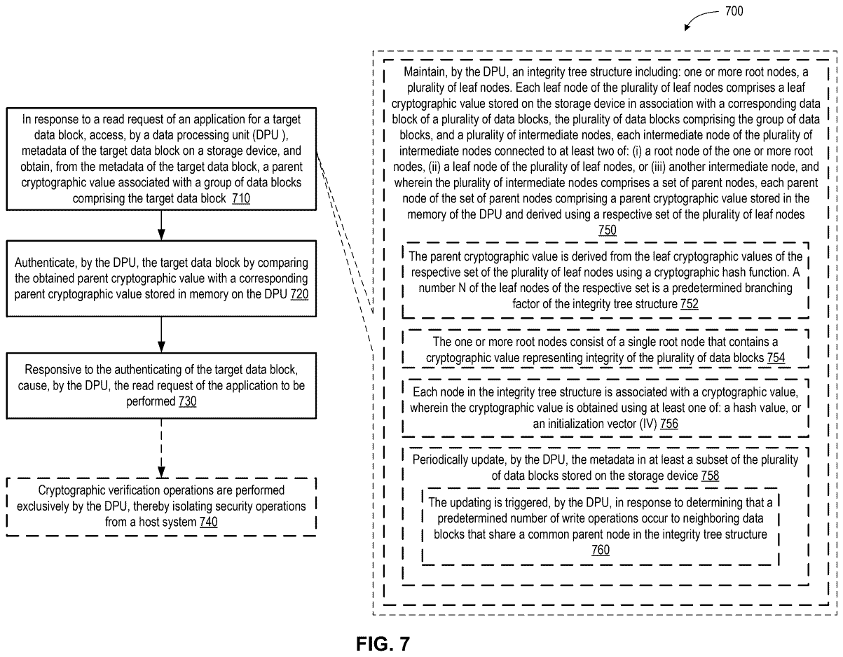

FIG. 7 is a flowchart for an example method 700 for handling read requests, according to at least one embodiment. At block 710, the DPU 106 (FIG. 1) can access metadata of a target data block on the storage device 118 in response to a read request from an application for the target data block. As illustrated in FIG. 3 at block 320, this access can occur via a single atomic NVMe operation that retrieves both the data block and its associated metadata simultaneously, such as reading data block B3 540 and metadata 542 shown in FIG. 5A. The DPU 106 can obtain, from the metadata, a parent cryptographic value associated with a group of data blocks comprising the target data block.

At block 720, the DPU 106 can authenticate the target data block by comparing the obtained parent cryptographic value with a corresponding parent cryptographic value stored in the memory 108 on the DPU 106. This comparison process is illustrated in FIG. 5A through comparison 526, where the parent hash H(parent) from metadata 542 is compared with the parent node 506 value H(H(B2)|H(B3)) stored in DPU memory.

At block 730, the DPU 106 can cause the read request of the application to be performed responsive to the authenticating of the target data block. As shown in FIG. 5A, when the hash values match 522, the DPU provides 544 the data for block 3 to the requesting application.

At block 740, the DPU 106 can perform cryptographic verification operations exclusively. This approach can isolate security operations from the host system 102.

In some embodiments, at block 750, the DPU 106 may maintain an integrity tree structure including one or more root nodes, a plurality of leaf nodes, and a plurality of intermediate nodes. As illustrated in FIG. 2B (example organization 214), the integrity tree structure may include intermediate nodes, such as intermediate I1 218 and intermediate I2 220) positioned between the root node 216 and parent nodes (222, 224, 226, and 228). Each leaf node can include a leaf cryptographic value stored on the storage device 118 in association with a corresponding data block. Each intermediate node can be connected to at least two of: a root node, a leaf node, or another intermediate node. The plurality of intermediate nodes can comprise a set of parent nodes (e.g., the parent nodes 112-2, . . . , 112-N). Each parent node can include a parent cryptographic value stored in the memory 108 of the DPU 106. Each parent node can be derived using a respective set of the plurality of leaf nodes.

In some embodiments, at block 752, the parent cryptographic value may be derived from leaf cryptographic values of the respective set of leaf nodes using a cryptographic hash function. A number N of the leaf nodes of the respective set can be a predetermined branching factor of the integrity tree structure.

In some embodiments, at block 754, the one or more root nodes may include a single root node that can contain a cryptographic value representing integrity of the plurality of data blocks.

In some embodiments, at block 756, each node in the integrity tree structure may be associated with a cryptographic value. The cryptographic value can be obtained using at least one of: a hash value, or an initialization vector (IV).

In some embodiments, at block 758, the DPU 106 may periodically update the metadata in at least a subset of the plurality of data blocks stored on the storage device 118.

In some embodiments, at block 760, the updating may be triggered by the DPU 106 in response to determining that a predetermined number of write operations occur to neighboring data blocks that share a common parent node in the integrity tree structure.

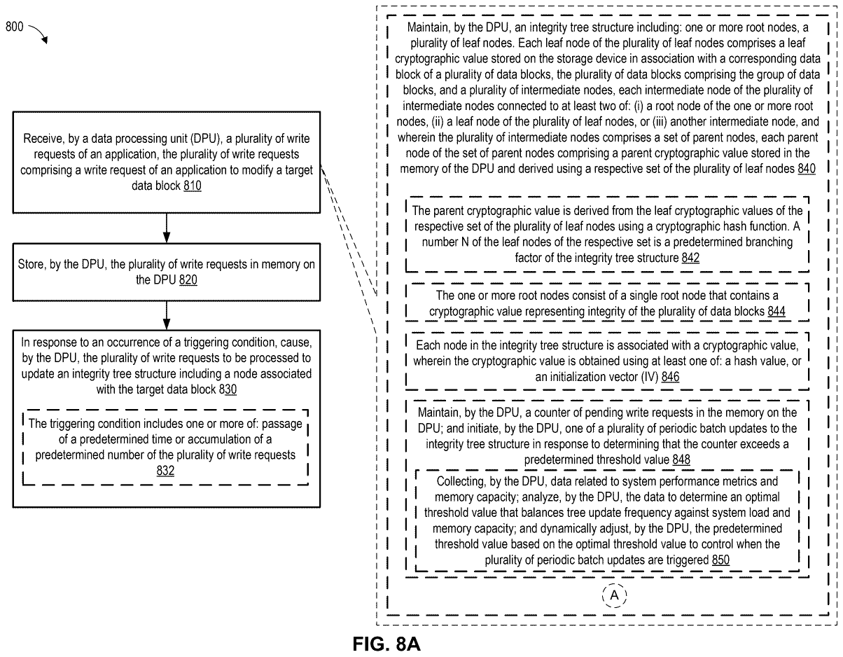

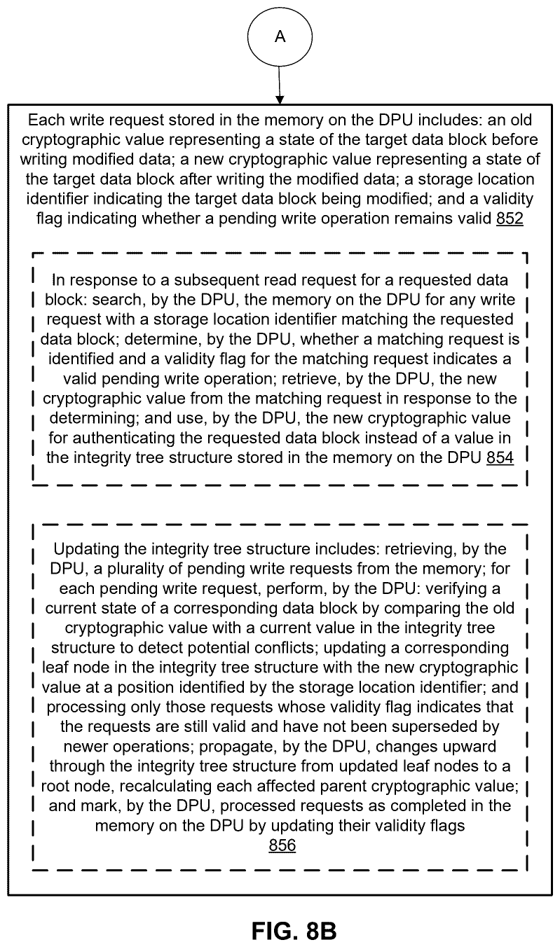

FIGS. 8A and 8B show a flowchart for an example method 800 for handling write requests, according to at least one embodiment. At block 810, the DPU 106 can receive a plurality of write requests from applications. The plurality of write requests can include a write request to modify a target data block. For example, as illustrated in FIG. 4A at block 404, the applications 104 may generate write requests, such as the request to modify Block #42.

At block 820, the DPU 106 can store the plurality of write requests in memory on the DPU 106 (e.g., as a pending write request 116 in the secure on-chip storage 114). An example storage process is described above in reference to FIG. 4A at block 406, where write requests are stored using the format 412 shown in the secure on-chip storage 410, including old-hash, new_hash, location, and validity fields.

At block 830, the DPU 106 can cause the plurality of write requests to be processed to update an integrity tree structure comprising a node associated with the target data block. The processing can occur in response to an occurrence of a triggering condition. This batch processing is illustrated in FIG. 4B starting at block 422, where the trigger condition based on counter 414 reaching threshold initiates the batch update process 420.

In some embodiments, at block 832, the triggering condition may include one or more of: passage of a predetermined time or accumulation of a predetermined number of the plurality of write requests.

In some embodiments, at block 840, the DPU 106 may maintain the integrity tree structure including one or more root nodes, a plurality of leaf nodes, and a plurality of intermediate nodes. Each leaf node may include a leaf cryptographic value stored on the storage device 118 in association with a corresponding data block. Each intermediate node may be connected to at least two of: a root node, a leaf node, or another intermediate node. The plurality of intermediate nodes may include a set of parent nodes. Each parent node may include a parent cryptographic value stored in the memory 108 of the DPU 106. Each parent node can be derived using a respective set of the plurality of leaf nodes.

In some embodiments, at block 842, the parent cryptographic value may be derived from leaf cryptographic values of the respective set of leaf nodes using a cryptographic hash function. A number N of the leaf nodes of the respective set can be a predetermined branching factor of the integrity tree structure.

In some embodiments, at block 844, the one or more root nodes may include a single root node that can contain a cryptographic value representing integrity of the plurality of data blocks.

In some embodiments, at block 846, each node in the integrity tree structure may be associated with a cryptographic value. The cryptographic value can be obtained using at least one of: a hash value, or an initialization vector (IV).

In some embodiments, at block 848, the DPU 106 may maintain a counter of pending write requests in the memory 108 on the DPU 106. As shown in FIG. 4A, the pending write counter 414 can track the requests (e.g., 97 requests) against a configurable threshold (e.g., 100). The DPU 106 may initiate one of a plurality of periodic batch updates to the integrity tree structure in response to determining that the counter exceeds a predetermined threshold value.

In some embodiments, at block 850, the DPU 106 may collect data related to system performance metrics and memory capacity. The DPU 106 may analyze the data to determine an optimal threshold value that balances tree update frequency against system load and memory capacity. The DPU 106 may dynamically adjust the predetermined threshold value based on the optimal threshold value to control when the plurality of periodic batch updates are triggered.

Referring next to FIG. 8B, in some embodiments, at block 850, each write request stored in the memory on the DPU 106 may include an old cryptographic value representing a state of the target data block before writing modified data. The write request may include a new cryptographic value representing a state of the target data block after writing the modified data. The write request may include a storage location identifier indicating the target data block being modified. The write request may also include a validity flag indicating whether a pending write operation remains valid.

In some embodiments, at block 852, in response to a subsequent read request for a requested data block, the DPU 106 may search the memory on the DPU 106 for any write request with a storage location identifier matching the requested data block. The DPU 106 may determine whether a matching request is identified and a validity flag for the matching request indicates a valid pending write operation. The DPU 106 may retrieve the new cryptographic value from the matching request in response to the determining. The DPU 106 may use the new cryptographic value for authenticating the requested data block instead of a value in the integrity tree structure stored in the memory 108 on the DPU 106.

At block 854, the DPU 106 may update the integrity tree structure by retrieving a plurality of pending write requests from the memory. An example batch update process is described above in reference to FIG. 4B and illustrated through the integrity tree update process 434, showing the before state 436 and after state 450 of the tree structure. For multi-level trees, this process would propagate through intermediate nodes as shown in FIG. 2B organization 214. For each pending write request, the DPU 106 may verify a current state of a corresponding data block by comparing the old cryptographic value with a current value in the integrity tree structure to detect potential conflicts. The DPU 106 may update a corresponding leaf node in the integrity tree structure with the new cryptographic value at a position identified by the storage location identifier. The DPU 106 may process only those requests whose validity flag indicates that the requests are still valid and have not been superseded by newer operations. The DPU 106 may propagate changes upward through the integrity tree structure from updated leaf nodes to a root node, recalculating each affected parent cryptographic value. The DPU 106 can mark processed requests as completed in the memory on the DPU 106 by updating their validity flags.

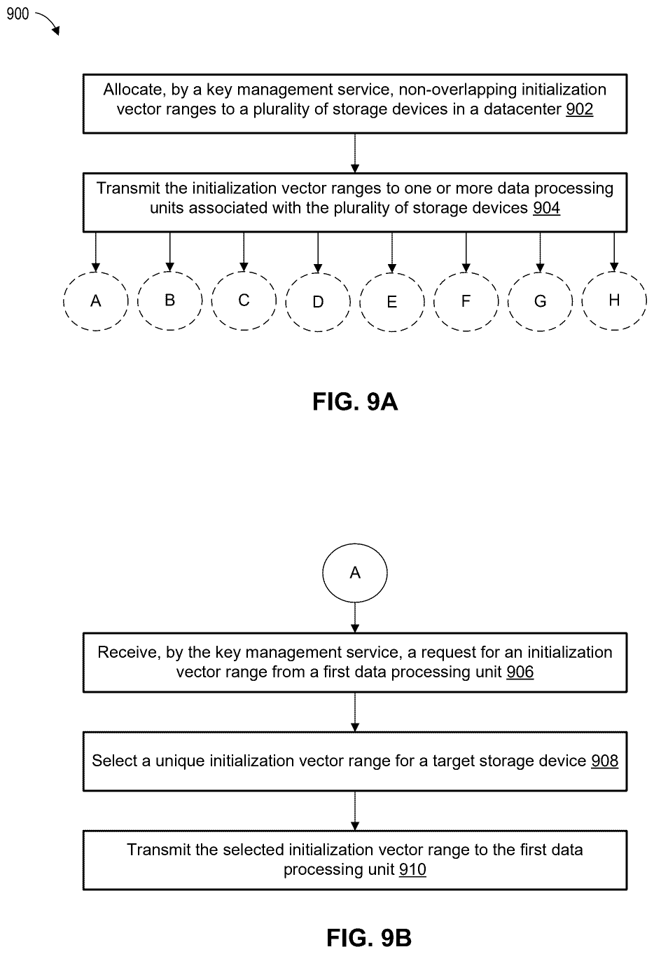

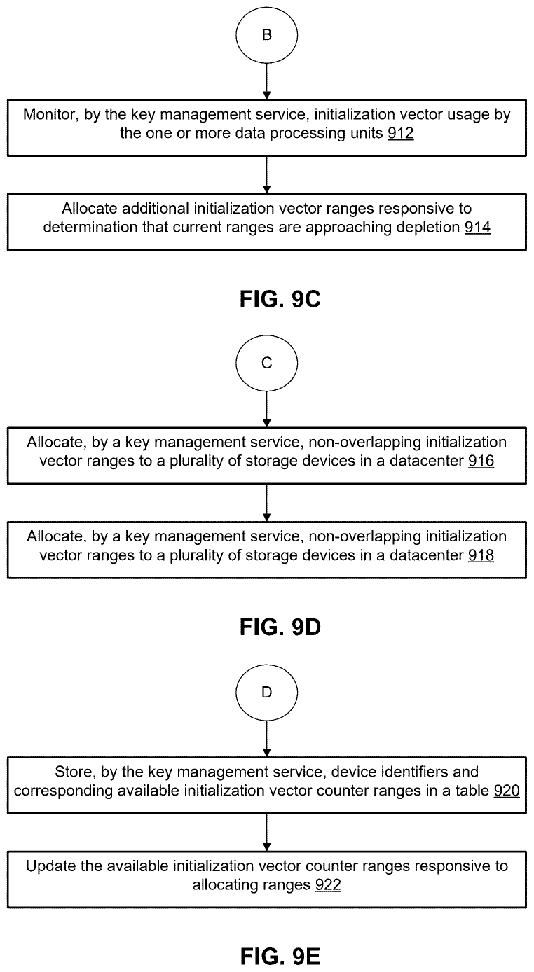

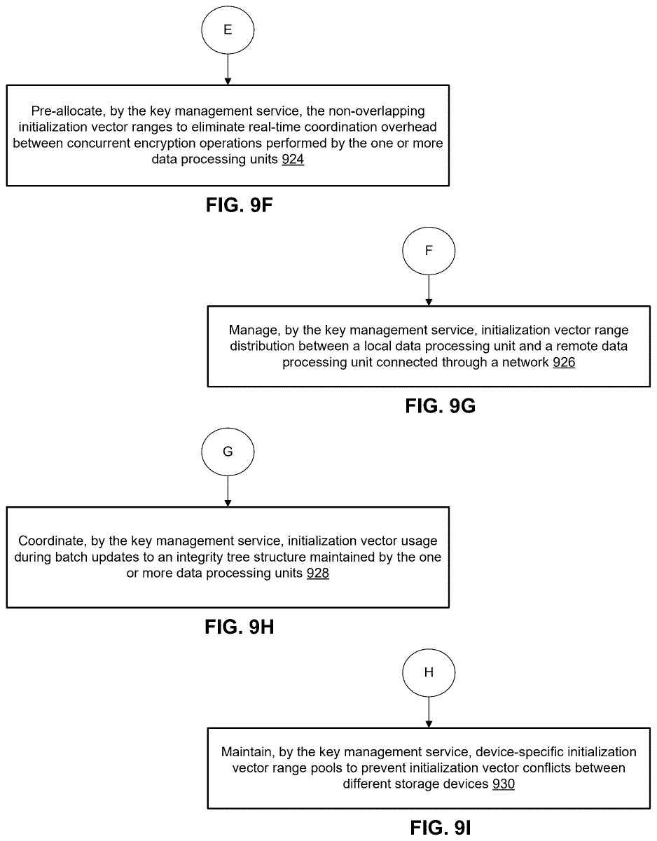

FIGS. 9A-9I show a flowchart for an example method 900 for initialization vector range allocation by a key management service, according to at least one embodiment. The method may be performed by the key management service 624 (FIG. 6).

At block 902, the key management service 624 allocates non-overlapping initialization vector ranges to a plurality of storage devices in a data center. At block 904, the key management service 624 transmits the initialization vector ranges to data processing units associated with the plurality of storage devices. This method can enable the key management service 624 to perform data center-scale IV coordination by distributing unique ranges to prevent IV reuse across multi-tenant encryption operations. The allocation process can utilize device-level tables (such as table 634 in FIG. 6) to track available initialization vector counter ranges and ensure no overlap occurs between different storage devices.

FIG. 9B shows steps for the request-response protocol between data processing units and the key management service 624, according to at least one embodiment. In some embodiments, the key management service 624 may receive a request for an initialization vector range from a first data processing unit (such as local DPU 614 in FIG. 6) at block 906. At block 908, the key management service 624 selects a unique initialization vector range for a target storage device. This selection process may utilize the extended table 634 shown in FIG. 6, which stores device identifiers, device keys, and corresponding free IV counter ranges for storage devices, such as SSD 0, SSD1, through SSD N 648. At block 910, the key management service 624 transmits the selected initialization vector range to the first data processing unit. This protocol can establish secure communication between the key management service 624 and data processing units, ensuring that each storage device receives appropriate IV ranges for encryption operations.

FIG. 9C illustrates dynamic range management operations performed by the key management service 624, according to at least one embodiment. In some embodiments, the key management service 624 may monitor initialization vector usage by the one or more data processing units at block 912. At block 914, the key management service 624 allocates additional initialization vector ranges responsive to determination that current ranges are approaching depletion. This monitoring process can prevent IV range exhaustion by proactively managing capacity across the data center infrastructure, ensuring continuous availability of unique initialization vectors for encryption operations.

FIG. 9D shows repetition of core allocation steps for emphasis, according to at least one embodiment. In some embodiments, the key management service 624 may perform the fundamental allocation operation at block 916, allocating non-overlapping initialization vector ranges to a plurality of storage devices in a data center. At block 918, the key management service 624 repeats the allocation process to demonstrate the scalable nature of the IV range distribution system across multiple storage devices and data processing units.

FIG. 9E depicts table-based range tracking operations performed by the key management service 624, according to at least one embodiment. In some embodiments, the key management service 624 may store device identifiers and corresponding available initialization vector counter ranges in a table (such as table 634 in FIG. 6) at block 920. At block 922, the key management service 624 updates the available initialization vector counter ranges responsive to allocating ranges. This table management process can maintain accurate records of IV range assignments and availability, enabling efficient allocation decisions and preventing overlap between different storage devices.

FIG. 9F shows performance optimization through pre-allocation, according to at least one embodiment. In some embodiments, the key management service 624 may pre-allocate the non-overlapping initialization vector ranges to eliminate real-time coordination overhead between concurrent encryption operations performed by the one or more data processing units at block 924. This pre-allocation approach can significantly improve system performance by avoiding expensive synchronization mechanisms that would otherwise create bottlenecks during high-volume encryption operations across thousands of concurrent tenants.

FIG. 9G illustrates support for disaggregated architecture, according to at least one embodiment. In some embodiments, the key management service 624 may manage initialization vector range distribution between a local data processing unit (such as local DPU 614 in FIG. 6) and a remote data processing unit (such as target DPU 646 in FIG. 6) connected through a network (such as network 620 in FIG. 6) at block 926. This management capability can enable the key management service 624 to coordinate IV allocation across distributed DPU architectures while maintaining security across untrusted network connections.

FIG. 9H depicts integration with integrity tree operations, according to at least one embodiment. In some embodiments, the key management service 624 may coordinate initialization vector usage during batch updates to an integrity tree structure maintained by the one or more data processing units at block 928. This coordination process can ensure IB uniqueness during the batch processing operations illustrated in FIG. 4B and FIG. 5B, where new IVs (e.g., the new IV 568) are calculated and integrated into the integrity tree updates through hash 560 calculations. IV allocation can align with batch processing operations (such as those shown in FIG. 4B) performed by data processing units during integrity tree updates, maintaining cryptographic consistency across the disaggregated storage system.

FIG. 9I shows device-specific range isolation operations, according to at least one embodiment. In some embodiments, the key management service 624 may maintain device-specific initialization vector range pools to prevent initialization vector conflicts between different storage devices at block 930. This isolation mechanism can ensure that each storage device (such as SSD 0, SSD 1, SSD 2, and SSD N 648 in FIG. 6) operates with dedicated IV ranges, preventing cross-device conflicts while enabling efficient resource utilization across the data center infrastructure.

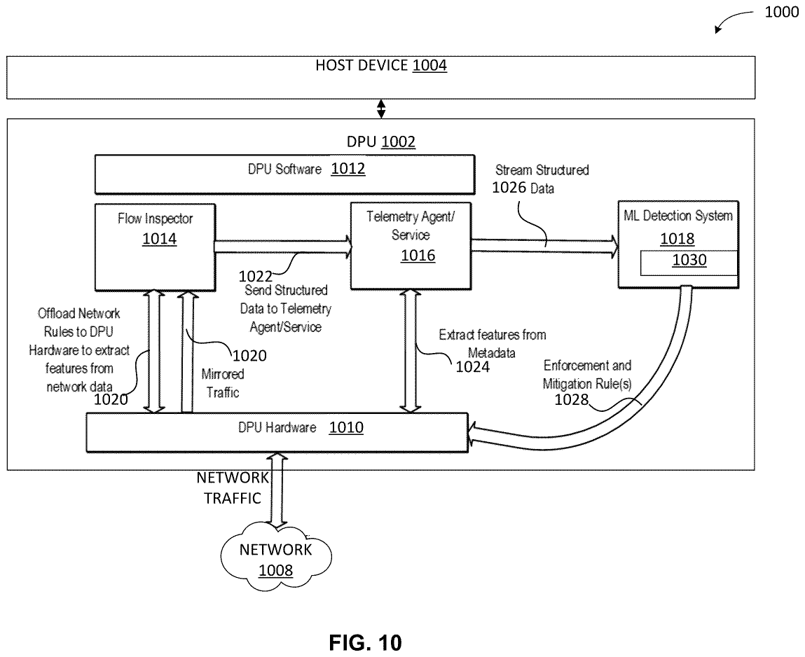

FIG. 10 is a block diagram of an example DPU-based system architecture 1000 according to at least one embodiment. The DPU-based system architecture 1000 (also referred to as “system” or “computing system” herein) includes a first integrated circuit, labeled DPU 1002, and a second integrated circuit, labeled host device 1004. The DPU-based system architecture 1000 can be part of a data center and include one or more data stores, one or more server machines, and other components of data center infrastructure. The DPU 1002 can be coupled to a network 1008. The network 1008 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In at least one embodiment, DPU 1002 is integrated as a System on a Chip (SoC) that is considered a data center infrastructure on a chip. In at least one embodiment, DPU 1002 includes DPU hardware 1010 and DPU software 1012 (e.g., software framework with acceleration libraries). The DPU hardware 1010 can include a CPU (e.g., a single-core or multi-core CPU), one or more hardware accelerators, memory, one or more host interfaces, and one or more network interfaces. The software framework and acceleration libraries can include one or more hardware-accelerated services, including hardware-accelerated security service (e.g., NVIDIA DOCA), hardware-accelerated virtualization services, hardware-accelerated networking services, hardware-accelerated storage services, hardware-accelerated artificial intelligence/machine learning (AI/ML) services, and hardware-accelerated management services. As illustrated in FIG. 10, the hardware-accelerated security service can include data extraction logic 1014 and telemetry agent 1016 (agent or service), and the AI/ML service can include an ML detection system 1018. The data extraction logic 1014 and telemetry agent 1016 can extract feature data from network traffic received over the network 108 from a second device (or multiple devices) and/or metadata from the DPU hardware 1010.

In at least one embodiment, DPU 1002 may implement the disaggregated integrity tree verification described above in reference to FIGS. 1-8. Cryptographic operations may be offloaded from the host device 1004 to provide secure storage verification with zero-overhead reads and/or batched write processing. In at least one embodiment, DPU hardware 1010 and DPU software 1012 may be configured to maintain integrity tree structures in memory and perform read verification. In at least one embodiment, DPU 1002 may coordinate with key management services (KMS) to obtain unique initialization vector (IV) ranges for cryptographic operations, eliminating the need for real-time coordination between concurrent encryption operations across multiple storage devices. In at least one embodiment, DPU hardware 1010 and DPU software 1012 may be configured to request, manage, and/or utilize pre-allocated IV ranges for maintaining cryptographic uniqueness in multi-tenant data center environments. In at least one embodiment, the ML detection system 1018 may analyze storage access patterns and system performance metrics to optimize batch processing thresholds for write requests in the integrity tree structure and/or to predict when additional initialization vector ranges are needed. Additional details of the operations of data extraction logic 114, telemetry agent 1016, and ML detection system 118 are described below, according to at least one embodiment.

In at least one embodiment, the data extraction logic 1014 extracts storage operation metadata and/or system performance data from storage access patterns and/or DPU hardware counters for analysis by the ML detection system 1018. In at least one embodiment, the data extraction logic 1014 receives a copy of the network data 1020 (e.g., a mirrored copy of the network data 1020 directed to the host device 1004). The data extraction logic 1014 can be configured by a configuration file that specifies what type of data should be extracted from the network data 1020. The configuration file can specify one or more filters that extract for inclusion or remove from inclusion specified types of data from the network data 120. Since the network data can be a copy of the network data, the network traffic that does not meet the filtering criteria can be discarded or removed. The network traffic that meets the filtering criteria can be structured and streamed to the ML detection system 1018 for analysis. The data extraction logic 1014 can generate a data structure 1022 with the extracted data. The data structure 1022 can be any type of data structure, such as a struct, an object, a message, or the like. for example, the configuration file can specify that storage access traffic and integrity tree operations be extracted from the network data 1020. The configuration file can specify what storage performance metrics, write request patterns, batch processing latencies, and/or initialization vector usage data may be extracted for analysis by the ML detection system 1018 to optimize integrity tree operations and/or predict when additional IV ranges are needed.

In at least one embodiment, telemetry agent 1016 extracts metadata 1024 from one or more registers of the DPU hardware 1010. In at least one embodiment, the telemetry agent 1016 can be configured or programmed by a configuration file (same or different configuration file than the data extraction logic 1014) that specifies what metadata should be extracted from the DPU's hardware, such as from embedded counters, registers, or the like. For example, the configuration file can specify which values from counters, registers, or the like should be extracted by the telemetry agent to be streamed with the extracted network data. Some metadata 1024 can be associated or related to the network data 1020. Some metadata 1024 can be associated or related to the underlying hardware and not related to the network traffic. In at least one embodiment, the telemetry agent 1016 combines the data structure 1022 and metadata 1024 into stream data 1026. The telemetry agent 1016 sends the stream data 1026 to the ML detection system 1018 (e.g., accelerated AI/ML pipeline(s)) to analyze storage performance patterns and optimize integrity tree operations.

In at least one embodiment, responsive to analysis by the ML detection system 1018 of storage access patterns and write request frequencies, the ML detection system 1018 may send optimization parameters (shown as enforcement rule 1028) to the DPU hardware 1010 for adjusting batch processing thresholds and/or triggering integrity tree updates. The DPU hardware 1010 may implement these optimization parameters to improve storage verification performance. In at least one embodiment, the ML detection system 1018 can output performance optimization recommendations for the integrity tree system on the host device 1004. In at least one embodiment, ML detection system 1018 can send the optimization recommendations to the hardware-accelerated security service, and the hardware-accelerated security service can send performance alerts to another system, such as a security information and event management (SIEM) or extended detection and response (XDR) system. The alert can include information about storage security performance and recommended threshold adjustments. In at least one embodiment, ML detection system 1018 can send performance recommendations in addition to sending the enforcement rule 1028 to the DPU hardware 1010.

In at least one embodiment, the data extraction logic 1014 can extract one or more features and send the extracted features to the ML detection system 1018 with or without features extracted by the telemetry agent 1016. For example, data extraction logic 1014 can extract HTTP data, and the telemetry agent 1016 can extract corresponding metadata 1024 from the DPU hardware registers and counters. The telemetry agent 1016 can generate the stream data 1026 and send it to the ML detection system 1018. The stream data 1026 can include features extracted by the data extraction logic 1014. The stream data 1026 can include features extracted by the data extraction logic 1014 and the telemetry agent 1016. In another embodiment, the ML detection system 1018 includes feature extraction logic to extract a set of features from the stream data 1026. The stream data 1026 can be raw data extracted by the hardware-accelerated security service. In at least one embodiment, extracted features are input into a storage performance optimization system 1030. In at least one embodiment, the storage performance optimization system 1030 includes a tree-based ML model trained to determine optimal batch processing thresholds and predict initialization vector range depletion based on the extracted features.

In at least one embodiment, the DPU hardware 1010 includes a data buffer to store the network data 1020. In at least one embodiment, the DPU hardware 1010 creates a copy of the network data 1020 so that it can be filtered by the data extraction logic 1014 to extract the structured data (e.g., data structure 1022).

In at least one embodiment, data extraction logic 1014 can extract some features from network data 1020 and create a feature set, including categorical features, numerical features, binary features, or the like. The telemetry agent 1016 can extract numerical features from the telemetry data (i.e., metadata 1024). These numerical features can be combined into the feature set. In at least one embodiment, the ML model includes a tree-based model. In another embodiment, the storage performance optimization 1030 includes a neural network (e.g., a fully-connected neural network layer or a convolutional neural network (CNN)).

It should be noted that, unlike a CPU or a GPU, the DPU 1002 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 102 can be used as a stand-alone embedded processor. In at least one embodiment, DPU 102 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 1002 can be configured for traditional enterprises'modern cloud workloads and high-performance computing. In at least one embodiment, DPU 1002 can deliver a set of software-defined networking, storage, security, and management services at a data-center scale with the ability to offload, accelerate, and isolate data center infrastructure. In at least one embodiment, the management services include coordination with key management services (KMS) for initialization vector (IV) range allocation as described above in reference to FIGS. 6 and 9A-9I. In at least one embodiment, the management services handle IV range requests, monitor usage patterns, and coordinate range allocation across multiple storage devices to prevent IV reuse. In at least one embodiment, DPU 1002 can provide multi-tenant, cloud-native environments with these software services. In at least one embodiment, DPU 1002 can deliver data center services of up to hundreds of CPU cores, freeing up valuable CPU cycles to run business-critical applications. In at least one embodiment, DPU 1002 can be considered a new type of processor that is designed to process data center infrastructure software to offload and accelerate the compute load of virtualization, networking, storage, security, cloud-native AI/ML services, and other management services.

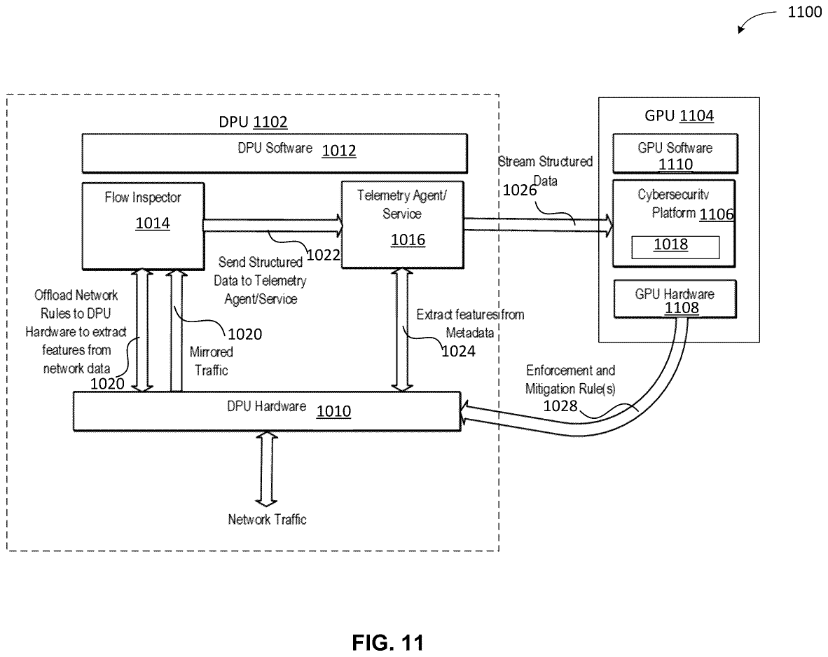

In at least one embodiment, DPU 1002 can include connectivity with packet-based interconnects (e.g., Ethernet), switched-fabric interconnects (e.g., InfiniBand, Fibre Channels, Omni-Path), or the like. In at least one embodiment, DPU 1002 can provide a data center that is accelerated, fully programmable, and configured with security (e.g., zero-trust security) to prevent data breaches and cyberattacks. In at least one embodiment, DPU 1002 can include a network adapter, an array of processor cores, and infrastructure offload engines with full software programmability. In at least one embodiment, DPU 1002 can sit at an edge of a server to provide flexible, secured, high-performance cloud and AI workloads. In at least one embodiment, DPU 1002 can reduce the total cost of ownership and increase data center efficiency. In at least one embodiment, DPU 1002 can provide the software framework and acceleration libraries (e.g., NVIDIA DOCA™) that enable developers to rapidly create applications and services for DPU 1002, such as security services, virtualization services, networking services, storage services, AI/ML services, and management services. In at least one embodiment, ML detection system 1018 is implemented in the AI/ML services. In another embodiment, ML detection system 1018 is implemented on one or more hardware accelerators or other components of the DPU hardware 1010. In at least one embodiment, the software framework and acceleration libraries make it easy to leverage hardware accelerators of DPU 1002 to provide data center performance, efficiency, and security. In at least one embodiment, the ML detection system 1018 is implemented in a GPU coupled to the DPU 1002, as illustrated in FIG. 11. The GPU can include one or more accelerated AI/ML pipelines described herein.

In at least one embodiment, DPU 1002 can provide networking services with a virtual switch (vSwitch), a virtual router (vRouter), network address translation (NAT), load balancing, and network virtualization (NFV). In at least one embodiment, DPU 1002 can provide storage services, including NVME™ over fabrics (NVMe-oF™) technology, elastic storage virtualization, hyper-converged infrastructure (HCI) encryption, data integrity, compression, data deduplication, or the like. NVM Express™ is an open logical device interface specification for accessing non-volatile storage media attached via the PCI Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N:M interconnection of elements, often in a peripheral context. The NVMe-oF™ technology enables the transport of the NVMe command set over a variety of interconnection infrastructures, including networks (e.g., Internet Protocol (IP)/Ethernet) and also I/O Channels (e.g., Fibre Channel). In at least one embodiment, DPU 1002 can provide hardware-accelerated security services using Next-Generation Firewall (FGFW), Intrusion Detection Systems (IDS), Intrusion Prevention System (IPS), a root of trust, micro-segmentation, distributed denial-of-service (DDoS) prevention technologies, and ML detection using data extraction logic 1014 and ML detection system 1018. NGFW is a network security device that provides capabilities beyond a stateful firewall, like application awareness and control, integrated intrusion prevention, and cloud-delivered threat intelligence. In at least one embodiment, the one or more network interfaces can include an Ethernet interface (single or dual ports) and an InfiniBand interface (single or dual ports). In at least one embodiment, the one or more host interfaces can include a PCIe interface and a PCIe switch. In at least one embodiment, the one or more host interfaces can include other memory interfaces. In at least one embodiment, the CPU can include multiple cores (e.g., up to 8 64-bit core pipelines) with L2 cache per two one or two cores and L3 cache with eviction policies support for double data rate (DDR) dual in-line memory module (DIMM) (e.g., DDR4 DIMM support), and a DDR4 DRAM controller. Memory can be on-board DDR4 memory with error correction code (ECC) error protection support. In at least one embodiment, the CPU can include a single core with L2 and L3 caches and a DRAM controller. In at least one embodiment, the one or more hardware accelerators can include a security accelerator, a storage accelerator, and a networking accelerator. In at least one embodiment, ML detection system 1018 is hosted by the security accelerator. In at least one embodiment, the security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, AES-GCM 128/256-bit key for data-at-rest encryption (e.g., Advanced Encryption Standard (AES) with ciphertext stealing (XTS) (e.g., AES-XTS AES-XTS 256/512), secure hash algorithm (SHA) 256-bit hardware acceleration, Hardware public key accelerator (e.g., Rivest- Shamir-Adleman (RSA), Diffie-Hellman, Digital Signal Algorithm (DSA), ECC, Elliptic Curve Cryptography Digital Signal Algorithm (EC-DSA), Elliptic-curve Diffie-Hellman (EC-DH)), and True random number generator (TRNG). In at least one embodiment, the storage accelerator can provide BlueField SNAP-NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (RoCE) RoCE, Zero Touch RoCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QoS) levels (e.g., 1K ingress and egress QoS levels). In at least one embodiment, DPU 102 can also provide boot options, including secure boot (RSA authenticated), remote boot over Ethernet, remote boot over Internet Small Computer System Interface (iSCSI), Preboot execution environment (PXE), and Unified Extensible Firmware Interface (UEFI).

In at least one embodiment, DPU 1002 can provide management services, including a 1 GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (eMMC) memory controller, Universal Asynchronous Receiver/Transmitter (UART), and Universal Serial Bus (USB).

In at least one embodiment, DPU 1002 can provide management services that integrate with the key management service (KMS) architecture described above in reference to FIGS. 6 and 9A-9I to coordinate initialization vector (IV) allocation across multiple storage devices in a data center environment. In at least one embodiment, the management services handle IV range requests from storage devices, monitor usage patterns to predict when additional ranges are needed, and/or maintain device-specific IV range pools to prevent conflicts between different storage devices.

In at least one embodiment, the hardware-accelerated security service is an adaptive cloud security service that provides adaptive storage security optimization, which may monitor integrity tree operations, analyze write request patterns, and coordinate with key management services for initialization vector allocation. The hardware-accelerated security service may act as the monitoring and optimization agent for storage security operations in disaggregated architectures. In at least one embodiment, hardware-accelerated security service acts as the monitoring or telemetry agent for DPU 1002 or a cybersecurity platform (e.g., FIG. 11), such as the NVIDIA Morpheus platform, which is an AI-enabled, cloud-native cybersecurity platform. The NVIDIA Morpheus platform is an open application framework that enables cybersecurity developers to create AI/ML pipelines for filtering, processing, and classifying large volumes of real-time data, allowing customers to continuously inspect network and server telemetry at scale. The NVIDIA Morpheus platform can provide information security to data centers, enabling dynamic protection, real-time telemetry, and adaptive defenses for detecting and remediating cybersecurity threats.

Previously, users, devices, data, and applications inside the data center were implicitly trusted, and perimeter security was sufficient to protect them from external threats. In at least one embodiment, DPU 1002, using hardware-accelerated security service, can define the security perimeter with a zero-trust protection model that recognizes that everyone and everything inside and outside the network cannot be trusted. Hardware-accelerated security service can enable network screening with encryption, granular access controls, and micro-segmentation on every host and for all network traffic. Hardware-accelerated security service can provide isolation, deploying security agents in a trusted domain separate from the host domain. If a host device is compromised, this isolation by hardware-accelerated security service prevents the attacker from knowing about or accessing hardware-accelerated security service, helping to prevent the attack from spreading to other servers. In at least one embodiment, the hardware-accelerated security service described herein can provide host monitoring, enabling cybersecurity vendors to create accelerated intrusion detection system (IDS) solutions to identify an attack on any physical or virtual machine. Hardware-accelerated security service can feed data about application status to SIEM or SIEM & XDR system. Hardware-accelerated security services can also provide enhanced forensic investigations and incident response.

As described above, attackers attempt to exploit breaches in security control mechanisms to move laterally across data center networks to other servers and devices. Hardware-accelerated security service described herein can enable security teams to shield their application processes, continuously validate their integrity, and, in turn, detect malicious activity. If an attacker terminates the security control mechanism's processes, the hardware-accelerated security service described herein can mitigate the attack by isolating the compromised host device, preventing the malware from accessing confidential data or spreading to other resources.

Conventionally, security tools run in the same host domain as the malware. So, stealthy malware can employ hiding techniques from the host device, enabling the malware to silently take over and tamper with agents and operating system (OS). For example, if anti-virus software is running on a host device that needs to continue operating or is not suspended, the hardware-accelerated security service described herein actively monitors the process to determine any anomalies, malware, or intrusion as described in more detail in the various embodiments described below. The malware runs in the host domain, and the hardware-accelerated security service runs in a separate domain from the host domain.

The host device 1004 may be a desktop computer, a laptop computer, a smartphone, a tablet computer, a server, or any suitable computing device capable of performing the techniques described herein. In some embodiments, the host device 1004 may be a computing device of a cloud-computing platform. For example, the host device 1004 may be a server machine of a cloud-computing platform or a component of the server machine. In such embodiments, the host device 1004 may be coupled to one or more edge devices (not shown) via network 1008. An edge device refers to a computing device that enables communication between computing devices at the boundary of two networks. For example, an edge device may be connected to host device 1004, one or more data stores, one or more server machines via network 1008, and may be connected to one or more endpoint devices (not shown) via another network. In such an example, the edge device can enable communication between the host device 1004, one or more data stores, one or more server machines, and one or more client devices. In other or similar embodiments, host device 1004 may be an edge device or a component of an edge device. For example, host device 1004 may facilitate communication between one or more data stores, one or more server machines connected to host device 1004 via network 1008, and one or more client devices connected to host device 104 via another network.

In still other or similar embodiments, host device 1004 can be an endpoint device or a component of an endpoint device. For example, host device 1004 may be, or may be a component of, devices, such as televisions, smartphones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, host device 104 may be connected to DPU 1002 over one or more network interfaces via network 108. In other or similar embodiments, host device 1004 may be connected to an edge device (not shown) via another network, and the edge device may be connected to DPU 1002 via a network.

In at least one embodiment, the host device 1004 executes one or more computer programs. One or more computer programs can be any process, routine, or code executed by the host device 1004, such as a host OS, an application, a guest OS of a virtual machine, or a guest application, such as executed in a container. Host device 1004 can include one or more CPUs of one or more cores, one or more multi-core CPUs, one or more GPUs, one or more hardware accelerators, or the like.

In at least one embodiment, one or more computer programs reside in a first computing domain (e.g., a host domain), and hardware-accelerated security service and ML detection system 1018 reside in a second computing domain (e.g., DPU domain or infrastructure domain) different than the first computing domain. In at least one embodiment, the malicious activity is caused by malware, and hardware-accelerated security service is out-of-band security software in a trusted domain that is different and isolated from the malware. That is, the malware may reside in a host domain, and hardware-accelerated security service, being in the trusted domain, can monitor the physical memory to detect the malware in the host domain. In at least one embodiment, DPU 1002 includes a direct memory access (DMA) controller (not illustrated in FIG. 10) coupled to a host interface. The DMA controller can read the data from the host's physical memory via a host interface. In at least one embodiment, the DMA controller reads data from the host's physical memory using the PCIe technology. Alternatively, other technologies can be used to read data from the host's physical memory.

Although various embodiments described above are directed to embodiments where hardware-accelerated security service and ML detection system 1018 are implemented in separate computing devices, including DPU 1002 and accelerated AI/MI pipelines (e.g., on a GPU coupled to the DPU), in other embodiments, operations are performed on single DPU 1002. In other embodiments, DPU 1002 may be any computing system or computing device capable of performing the techniques described herein.

In at least one embodiment, the host device 1004 resides in a first computing domain (e.g., a host domain), and hardware-accelerated security service and ML detection system 1018 reside in a second computing domain (e.g., DPU domain) different than the first computing domain. In another embodiment, the host device 1004 resides in a first computing domain (e.g., a host domain), hardware-accelerated security service resides in a second computing domain (e.g., DPU domain), and ML detection system 1018 resides in a third computing domain different than the first and second computing domains.

Although FIG. 10 illustrates the ML detection system 1018 as part of the DPU 1002, in other embodiments, the ML detection system 1018 can be implemented on a separate device, such as a GPU with an accelerated AI/ML pipeline, such as illustrated in FIG. 11. In this embodiment, the GPU (or accelerated AI/ML pipeline) is coupled to the DPU 1002 and can host the ML detection system 1018. In at least one embodiment, the ML detection system 1018 is the NVIDIA MORPHEUS cybersecurity platform. The accelerated AI/ML pipeline can perform pre-processing operations, inferences, post-processing operations, actions, or any combination thereof. The accelerated AI/ML pipeline can be a combination of hardware and software, such as the NVIDIA EXG platform, and software for accelerating AI/ML operations on the NVIDIA EXG platform. For example, the accelerated AI/ML pipeline can provide advantages in accelerating processes up to 60 times compared to a CPU. The accelerated AI/ML pipeline can also provide an advantage of a number of inferences that can be done in parallel (e.g., up to millions of inferences in parallel).

FIG. 11 is a block diagram of an example DPU-based system architecture 1100, according to at least one embodiment. The DPU-based system architecture 1100 is similar to DPU-based system architecture 1000, as noted by similar reference numbers, except as set forth below. The DPU-based system architecture 1100 includes a first integrated circuit, labeled DPU 1102, and a second integrated circuit, labeled GPU 1104. The GPU 1104 can host a cybersecurity platform 1106, such as an accelerated AI/ML pipeline, that hosts the ML detection system 1018 remotely from the DPU 1102. In at least one embodiment, the accelerated AI/ML pipeline can be part of the NVIDIA MORPHEUS cybersecurity platform. As described above, the NVIDIA Morpheus platform is an AI-enabled, cloud-native cybersecurity platform. The NVIDIA Morpheus platform is an open application framework that enables cybersecurity developers to create AI/ML pipelines for filtering, processing, and classifying large volumes of real-time data, allowing customers to continuously inspect network and server telemetry at scale. The NVIDIA Morpheus platform can provide information security to data centers to enable dynamic protection, real-time telemetry, and adaptive defenses for detecting and remediating cybersecurity threats. In at least one embodiment of FIG. 11, DPU 1102 extracts the network data 1020 and the metadata 1024 from the DPU hardware 1010 of the DPU 1102 in a similar manner as described above with respect to FIG. 10. The network data 1020 can be extracted from the network traffic received by the network interfaces of the DPU hardware 1010. The metadata 1024 can be extracted from registers, counters, or the like, of the DPU hardware 1010. In at least one embodiment, the DPU-based system architecture 1100 implements the disaggregated integrity tree system with GPU-accelerated batch processing for write operations. In at least one embodiment, the GPU 1104 can handle the batch updates described in FIGS. 4A-4B, processing multiple pending write requests simultaneously to update leaf nodes and propagate changes through the integrity tree structure.

In at least one embodiment, the DPU 1102 includes a data extraction logic 1014 (sometimes referred to as a flow inspector) that extracts the network data 1020 and a telemetry agent 1016 that extracts the metadata 1024 from the DPU hardware 1010, as described above. The flow inspector can be configured by a configuration file that specifies what type of data need to be extracted from the network data 1020. The configuration file can specify one or more filters that extract for inclusion or remove from inclusion particular data from the network data 1020. The flow inspector can generate a data structure 1022 with the extracted data. The data structure 1022 can be any type of data structure, such as a struct, an object, a message, or the like. For example, the configuration file can specify that all HTTP traffic be extracted from the network data 1020. The flow inspector sends the structured data (e.g., data structure 1022) to the telemetry agent 1016. In at least one embodiment, the telemetry agent 1016 can be programmed by a configuration file (same or different configuration file than the flow inspector) that specifies what metadata 1024 should be extracted from the DPU hardware 1010, such as from embedded counters, registers, or the like. For example, the configuration file can specify which values from counters, registers, or the like should be extracted by the telemetry agent 1016 to be streamed with the extracted network data. In at least one embodiment, the telemetry agent 1016 combines the metadata 1024 with the structured data (e.g., data structure 1022) into the stream data 126 (e.g., streamed structured data). Instead of sending the stream data 1026 to a locally-hosted ML detection system 1018, as described above with respect to FIG. 10, the telemetry agent 1016 can send the stream data 1026 to the GPU 1104 with the cybersecurity platform 1106. In this embodiment, the cybersecurity platform 1106 includes one or more accelerated AI/MI pipelines deployed on GPU hardware 1108. The cybersecurity platform 1106 can implement the ML detection system 1018.

In at least one embodiment, the DPU hardware 1010 includes a data buffer to store the network data 1020. In at least one embodiment, the DPU hardware 1010 creates a copy of the network data 1020 so that it can be filtered by the flow inspector to extract the structured data.

In at least one embodiment, a computing system includes the DPU 1102 and GPU 1104. The DPU 1102 has DPU hardware 1010, including a network interface, a host interface, a CPU, and an acceleration hardware engine. The DPU 1102 can implement a hardware-accelerated security service with the flow inspector and telemetry agent to collect and stream feature data to the cybersecurity platform 1106 to optimize storage security operations for integrity tree management. As described herein, the hardware-accelerated security service extracts a set of features from first data in network traffic received on the network interface and second data stored in registers in the DPU hardware 1010. The hardware-accelerated security service (flow inspector and telemetry agent) can combine the first feature data and the second feature data into the set of features. The GPU 1104, or other accelerated pipeline hardware, is coupled to the DPU 1002. The GPU 1104 has GPU software 1110, the cybersecurity platform 1106 hosting the ML detection system 1018, and GPU hardware 1108. The GPU 1104 determines, using the ML detection system 1018, storage performance patterns and integrity tree optimization opportunities based on the set of features. The GPU 1104 sends an enforcement rule 1028 to the DPU 1102 (e.g., DPU hardware 1010) responsive to identifying opportunities for batch processing threshold adjustments and/or IV range allocation optimization. The DPU 1002 can perform an action, associated with the enforcement rule 1028, to optimize subsequent storage operations and/or integrity tree updates.

In at least one embodiment, the first feature data includes write request frequency, batch processing latency, integrity tree depth, pending write counter values, storage device utilization, and initialization vector consumption rates. The second feature data can include one or more flags, one or more counts, or the like. The one or more flags and counts can be stored in registers or counters of the DPU hardware 1010.

In at least one embodiment, the host device resides in a first computing domain, and the DPU software 1012 resides in a second computing domain different from the first computing domain. The ML detection system 1018 can reside in the second computing domain (FIG. 10) or a third computing domain (FIG. 11) different from the first computing domain and the second computing domain.

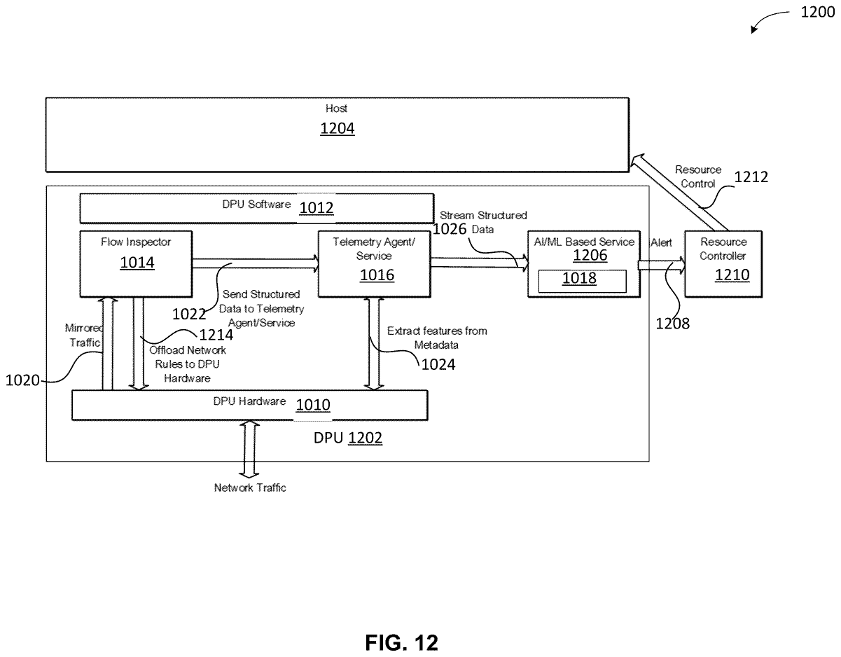

FIG. 12 is a block diagram of an example DPU-based system architecture 1200, according to at least one embodiment. The DPU-based system architecture 1200 is similar to DPU-based system architecture 1000, as noted by similar reference numbers, except as set forth below. The DPU-based system architecture 1200 includes a first integrated circuit, labeled DPU 1202. The DPU 1202 includes similar hardware and software components as the DPU 102 as described above, except the DPU 1202 includes an AI/ML-based service 1206 that implements the ML detection system 1018 locally on the DPU 1202. The AI/ML-based service 1206 can receive the stream data 1026 from the telemetry agent 1016, as described above. The AI/ML-based service 1206 can analyze, using the ML detection system 1018, storage performance patterns and integrity tree optimization opportunities for a host device 1024. Responsive to identifying suboptimal batch processing thresholds and/or IV range depletion patterns, the AI/ML-based service 1206 can send an alert 1208 to a resource controller 1210. The resource controller 1210 can be a provisioning server that provisions resources of or for the host device 304. The resource controller 1210 can be implemented on a separate device, such as the DPU 1202 and the host device 1204. The resource controller 1210 can send resource control information 1212 to the host device 1204 in response to the alert 1208. Alternatively, the alert 1208 can be an indication of storage performance optimization opportunities, and the resource controller 1210 can perform one or more operations to implement performance improvements and prevent storage security bottlenecks in response to the indication from the ML detection system 1018. In at least one embodiment, the DPU-based system architecture 1200 implements the integrity verification system with dynamic threshold management for optimizing batch processing performance locally on the DPU 1202. In at least one embodiment, the AI/ML-based service 1206 implements dynamic threshold adjustment for the pending write counter, analyzing system performance metrics to optimize when batch updates are triggered.

In at least one embodiment, the data extraction logic 1014 can receive mirrored network traffic data (e.g., network data 1020) from the DPU hardware 1010 (e.g., acceleration hardware engine). The data extraction logic 1014 can offload and filter the mirrored network traffic data based on predefined filters 1214 using the DPU hardware 1010 (e.g., acceleration hardware engine) to obtain filtered network traffic. The processing logic generates the first feature data from the filtered network traffic. The processing logic extracts the second feature data by extracting telemetry data from the registers of the DPU hardware 1010 (e.g., acceleration hardware engine). In at least one embodiment, the telemetry agent 1016 generates the second feature data from the telemetry data and combines the first feature data and the second feature data into a set of features. The telemetry agent 1016 sends the set of features to the DPU hardware 1010 (e.g., accelerated pipeline hardware).

In at least one embodiment, the DPU 1202 provides AI/ML-based storage optimization based on storage performance monitoring services that collect and analyze storage access patterns and integrity tree operations, telemetry services that gather performance metrics from DPU hardware counters, and/or the AI/ML-based service 1206 that analyzes these metrics to optimize batch processing thresholds and predict initialization vector range depletion. The AI/ML-based service 1206 may send optimization recommendations to DPU hardware 1010 for improved storage security performance.

Although various embodiments described above with respect to FIG. 1 to FIG. 12 are directed to solutions using a DPU, other embodiments can be implemented in other devices, such as a switch or a network interface card.

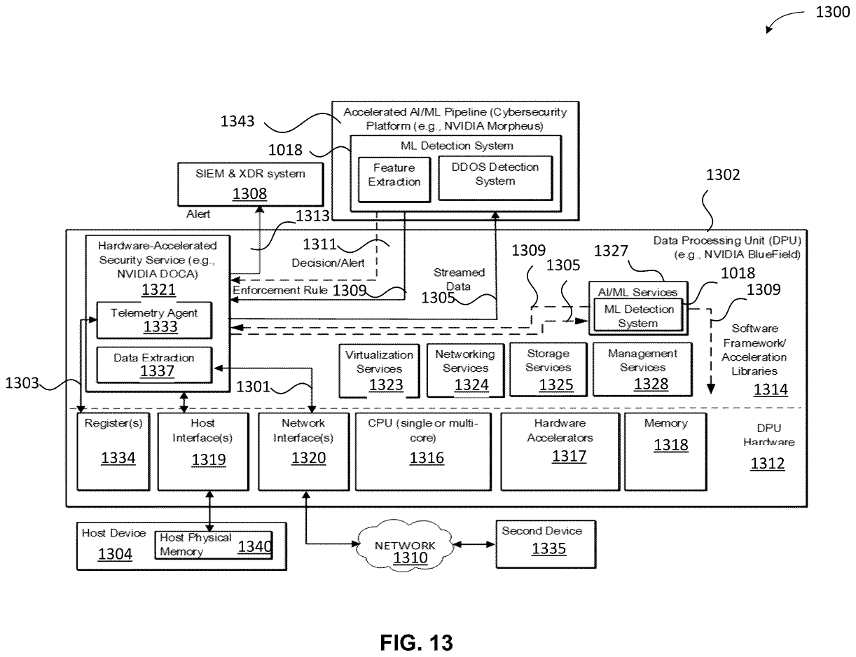

FIG. 13 is a block diagram of an example DPU-based system architecture 1300, according to at least one embodiment. The DPU-based system architecture 1300 (also referred to as “system” or “computing system” herein) includes an integrated circuit, labeled DPU 1302, a host device 1304, a SIEM or XDR system 1308. The DPU-based system architecture 1300 can be part of a data center and include one or more data stores, one or more server machines, and other components of data center infrastructure. In implementations, network 1310 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In at least one embodiment, the system architecture 1300 can implement initialization vector (IV) management services coordinated across distributed DPUs in a data center environment. In at least one embodiment, multiple DPUs can coordinate with external key management services to obtain non-overlapping IV ranges, enabling scalable cryptographic operations across storage devices without real-time coordination overhead.

In at least one embodiment, DPU 1302 is integrated as a SoC that is considered a data center infrastructure on a chip. In at least one embodiment, DPU 1302 includes DPU hardware 1312 and software framework with acceleration libraries 1314. The DPU hardware 1312 can include a CPU 1316 (e.g., a single-core or multi-core CPU), one or more hardware accelerators 1317, memory 1318, one or more host interfaces 1319, and one or more network interfaces 1320. The software framework and acceleration libraries 1314 can include one or more hardware-accelerated services, including hardware-accelerated security service 1321 (e.g., NVIDIA DOCA), hardware-accelerated virtualization services 1323, hardware-accelerated networking services 1324, hardware-accelerated storage services 1325, hardware-accelerated artificial intelligence/machine learning (AI/ML) 1327, and hardware-accelerated management services 1328. In at least one embodiment, DPU 1302 is coupled to an accelerated AI/ML pipeline 1343. In at least one embodiment, the accelerated AI/ML pipeline 1343 can be a GPU coupled to the DPU 1302. In at least one embodiment, the accelerated AI/ML pipeline 1343 can host an ML detection system 1018 that includes one or more ML detection models trained to analyze storage performance patterns and/or identify integrity tree optimization opportunities for the host device 1304. In at least one embodiment, the accelerated AI/ML pipeline 1343 is the NVIDIA MORPHEUS cybersecurity platform. Accelerated AI/ML pipeline 1343 can perform pre-processing operations, inferences, post-processing operations, actions, or any combination thereof. Accelerated AI/ML pipeline 1343 can be a combination of hardware and software, such as the NVIDIA EXG platform and software for accelerating AI/ML operations on the NVIDIA EXG platform. For example, accelerated AI/ML pipeline 1343 can provide advantages in accelerating processes up to 60 times compared to a CPU. Accelerated AI/ML pipeline 1343 can also provide an advantage of a number of inferences that can be done in parallel (e.g., up to millions of inferences in parallel). The host device 1304 can include host physical memory 1340. The host physical memory 1340 can include one or more volatile and/or non-volatile memory devices that are configured to store the data of host device 1304. In at least one embodiment, the ML detection system 1018 may include a storage performance analysis system, a write pattern optimization system, an initialization vector usage prediction system, and/or other storage security optimization modules.

In at least one embodiment, hardware-accelerated security service 1321 includes data extraction logic 1337, which may monitor storage and extract storage operation data and performance metrics from integrity tree operations. In at least one embodiment, hardware-accelerated security service 1321 may coordinate with key management services for initialization vector allocation. In at least one embodiment, the hardware-accelerated security service 1321 receives a copy of the network data 1301 (e.g., a mirrored copy of the network data 1301 directed to the host device 1304). The data extraction logic 1337 can be configured by a configuration file that specifies what type of data should be extracted from the network data 1301. The configuration file can specify one or more filters that extract for inclusion or remove from inclusion specified types of data from the network data 1301. Since the network data can be a copy, the network traffic that does not meet the filtering criteria can be discarded or removed. The network traffic that meets the filtering criteria can be structured and streamed to the cybersecurity platform for analysis. The data extraction logic 1337 can generate a data structure with the extracted data. The data structure can be any type of data structure, such as a struct, an object, a message, or the like. For example, the configuration file can specify that all HyperText Transport Protocol (HTTP) traffic be extracted from the network data 1301. The configuration file can specify that all traffic on port 80, port 443, and/or port 22 should be extracted from the network data 1301 for analysis. A large percentage of attacks target these three ports: SSH-22/TCP, HTTPS-443/TCP, and HTTP-80/TCP.

In at least one embodiment, hardware-accelerated security service 1321 includes a telemetry agent 1333 that extracts metadata 1303 from one or more registers 1334 of the DPU hardware 1012. In at least one embodiment, the telemetry agent 1333 can be configured or programmed by a configuration file (same or different configuration file than the data extraction logic 1337) that specifies what metadata should be extracted from the DPU's hardware, such as from embedded counters, registers, or the like. For example, the configuration file can specify which values from counters, registers, or the like, should be extracted by the telemetry agent to be streamed with the extracted network data. Some metadata 1303 can be associated or related to the network data 1301. Some metadata 1303 can be associated or related to the underlying hardware and not related to the network traffic. In at least one embodiment, the telemetry agent 1333 can also send the data structure with the extracted network data 1301 and extracted metadata 1303 to the cybersecurity platform (e.g., accelerated AI/ML pipeline(s) 1343).

In at least one embodiment, the telemetry agent 1333 combines the extracted network data 1301 and the metadata 1303 into streamed data 1305. The telemetry agent 1333 sends the streamed data 1305 to the ML detection system 1018 to analyze storage performance patterns and integrity tree optimization opportunities. Responsive to identifying opportunities for batch processing optimization and/or IV range management improvements by the ML detection system 1018, the ML detection system 1018 sends an enforcement rule 1309 to the DPU 1302. The hardware-accelerated security service 1321 can perform an action, associated with the enforcement rule 1309, to optimize subsequent storage operations and integrity tree processing for the host device 1304. In at least one embodiment, the ML detection system 1018 can output optimization recommendations 1311, such as batch processing threshold adjustments and initialization vector range allocation requests. These recommendations can be used to optimize storage security performance. ML detection system 1018 can send indication 1311 (e.g., performance optimization decision/alert) to hardware-accelerated security service 1321, and hardware-accelerated security service 1321 can send an alert 1313 to SIEM or SIEM & XDR system 1308. In at least one embodiment, ML detection system 1018 can send an indication to SIEM or SIEM & XDR system 1308, in addition to or instead of sending indication 1311 to hardware-accelerated security service 1321.

In at least one embodiment, data extraction logic 1337 has feature extraction logic to extract one or more features and send the extracted features to ML detection system 1018 instead of the extracted data. For example, data extraction logic 1337 can extract HTTP data, and the telemetry agent 1333 can extract corresponding metadata 1303 from the DPU hardware registers and counters. The data extraction logic 1337 can generate the streamed data 1305 and send it to the ML detection system 1018. In another embodiment, the ML detection system 1018 includes feature extraction logic to extract a set of features from the streamed data 1305. The streamed data can be raw extracted data from the hardware-accelerated security service 1321.

In another embodiment, as illustrated in FIG. 13, the ML detection system 1018 can be hosted locally in the AI/ML services 1327. In this embodiment, the hardware-accelerated security service 1321 can send the streamed data 1305 to the AI/ML services 1327. The ML detection system 1018 of the AI/ML services 1327 can analyze storage performance patterns and identify integrity tree optimization opportunities for the host device 1304. Responsive to identifying performance optimization opportunities, the AI/ML services 1327 can send an enforcement rule 1309 to the hardware-accelerated security service 1321. Alternatively, the AI/ML services 1327 can send the enforcement rule 1309 to the DPU hardware 1312.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
allocating, by a key management service, non-overlapping initialization vector ranges to a plurality of storage devices in a data center; and
transmitting the initialization vector ranges to one or more data processing units associated with the plurality of storage devices.

2. The method of claim 1, further comprising:
receiving, by the key management service, a request for an initialization vector range from a first data processing unit;
selecting a unique initialization vector range for a target storage device; and
transmitting the selected initialization vector range to the first data processing unit.

3. The method of claim 1, further comprising:
monitoring, by the key management service, initialization vector usage by the one or more data processing units; and
allocating additional initialization vector ranges responsive to determination that current ranges are approaching depletion.

4. The method of claim 1, further comprising:
storing, by the key management service, device identifiers and corresponding available initialization vector counter ranges in a table; and
updating the available initialization vector counter ranges responsive to allocating ranges.

5. The method of claim 1, wherein preventing initialization vector reuse comprises:
pre-allocating, by the key management service, the non-overlapping initialization vector ranges to eliminate real-time coordination overhead between concurrent encryption operations performed by the one or more data processing units.

6. The method of claim 1, further comprising:
managing, by the key management service, initialization vector range distribution between a local data processing unit and a remote data processing unit connected through a network.

7. The method of claim 1, further comprising:
coordinating, by the key management service, initialization vector usage during batch updates to an integrity tree structure maintained by the one or more data processing units.

8. The method of claim 1, further comprising:
maintaining, by the key management service, device-specific initialization vector range pools to prevent initialization vector conflicts between different storage devices.

9. A method comprising:
establishing a local Data Processing Unit (DPU) as a trusted execution environment for confidentiality operations and integrity operations;
establishing a remote DPU as another trusted execution environment for freshness verification operations;
maintaining a host system in an untrusted state that receives application workload requests;
processing, on the local DPU, the confidentiality operations and the integrity operations for data blocks stored on a storage device;
processing, on the remote DPU, the freshness verification operations for the data blocks using an integrity tree structure; and
coordinating between the local DPU and the remote DPU through an untrusted network, producing verified secure storage operations.

10. The method of claim 9, further comprising:
performing infrastructure attestation for device discovery operations on the local DPU;
performing remote attestation between the local DPU and the remote DPU using a secure communication protocol;
establishing Trusted Device Interface Security Protocol (TDISP) communication between a host CPU and the local DPU; and
combining attestation results from the infrastructure attestation and the remote attestation to create a zero-trust security architecture across system components.

11. The method of claim 10, wherein the remote attestation comprises:
verifying cryptographic credentials of the remote DPU;
validating hardware and firmware signatures of the storage device; and
confirming secure boot status of the remote DPU before establishing trust relationships.

12. The method of claim 9, further comprising:
performing, by the local DPU, encryption operations on data blocks using unique initialization vectors obtained from a key management service; and
performing, by the remote DPU, integrity tree verification operations using parent cryptographic values stored in memory.

13. The method of claim 9, further comprising:
writing, by the local DPU, data blocks to the storage device;
extracting, by the remote DPU, a parent cryptographic value from metadata of a data block stores on the storage device; and
comparing, by the remote DPU, the parent cryptographic value with a corresponding parent node value stored in memory on the remote DPU to verify freshness of the data block.

14. The method of claim 9, further comprising:
isolating security operations on the local DPU and the remote DPU from the host system to prevent compromise of cryptographic operations if the host system is compromised.

15. The method of claim 9, wherein processing freshness verification operations on the remote DPU comprises:
maintaining an integrity tree structure with root nodes and parent nodes in memory on the remote DPU;
storing leaf nodes of the integrity tree structure on the storage device; and
verifying data block freshness by comparing parent cryptographic values from metadata with corresponding parent nodes in the integrity tree structure.

16. The method of claim 9, further comprising:
establishing a Trusted Device Interface Security Protocol (TDISP) connection between a host CPU and the local DPU for secure communication; and
utilizing the TDISP connection to isolate trusted domain operations from untrusted host domain operations.

17. The method of claim 9, further comprising:
coordinating, by the local DPU, with a key management service to obtain non-overlapping initialization vector ranges for encryption operations; and
coordinating, by the remote DPU, with the key management service to obtain initialization vector ranges for integrity tree operations.

18. The method of claim 9, wherein processing confidentiality operations on the local DPU comprises:
computing cryptographic hash values for data blocks;
generating unique initialization vectors for encryption operations; and
encrypting data blocks using the unique initialization vectors before writing to the storage device.

19. The method of claim 9, wherein processing integrity operations on the local DPU comprises:
computing a cryptographic hash value for each data block during write operations;
storing the cryptographic hash value in metadata associated with the data block on the storage device; and
verifying the cryptographic hash value matches a corresponding value in an integrity tree structure during read operations.

20. A computer-implemented system for disaggregated secure storage, comprising:
a host system to generate data access requests;
a local Data Processing Unit (DPU) comprising secure on-chip storage and processing units to perform integrity and confidentiality operations;
a remote Data Processing Unit (DPU) to maintain an integrity tree structure with parent nodes in memory;
a storage device to store data blocks and leaf nodes of the integrity tree structure; and
a Key Management Service (KMS) to allocate non-overlapping initialization vector (IV) ranges for the integrity tree structure, wherein each node in the integrity tree structure is associated with a cryptographic value, wherein the cryptographic value is obtained using an IV;
wherein the system implements zero-overhead read paths and eventual consistency write paths.
